(19) United States
(12) Patent Application Publication
(10) Pub. No.: US 2026/0001540 A1
(43) Pub. Date: Jan. 1, 2026

(54) Vehicle Control Apparatus and Vehicle Control Method

(71) Applicants: Hyundai Motor Company, Seoul (KR); Kia Corporation, Seoul (KR)

(72) Inventors: Il Hwan Kim, Hwaseong-Si (KR); Ki Beom Lee, Hwaseong-Si (KR)

(21) Appl. No.: 18/965,711

(22) Filed: Dec. 2, 2024

(30) Foreign Application Priority Data
Jul. 1, 2024 (KR) 10-2024-0086309

(51) Int. Cl. B60W 30/14

(52) U.S. Cl. CPC B60W 30/143; B60W 2552/45; B60W 2554/4042; B60W 2554/801; B60W 2554/802

(57) ABSTRACT

An apparatus for controlling a vehicle is introduced. The apparatus may comprise a memory configured to store a parameter associated with speed-based distance adjustment, and a processor configured to determine, based on the parameter and a speed of the vehicle, at least one distance between the vehicle and at least one target, wherein the at least one distance varies based on the speed of the vehicle. The processor may identify, based on the at least one distance, a risk area among a plurality of risk areas, wherein at least one target is located in the risk area. The plurality of risk areas may be generated by dividing a sidewalk into a plurality of areas, wherein the sidewalk is within a threshold distance from a road on which the vehicle is traveling. The processor may determine a start point and an end point for controlling the vehicle speed.

### CROSS-REFERENCE TO RELATED APPLICATION

This application claims the benefit of priority to Korean Patent Application No. 10-2024-0086309, filed in the Korean Intellectual Property Office on Jul. 1, 2024, the entire contents of which are incorporated herein by reference.

### TECHNICAL FIELD

The present disclosure relates to a vehicle control apparatus and a vehicle control method, and more specifically, to a technology for controlling the speed of a vehicle if a pedestrian is detected on a sidewalk close to a road on which a vehicle is traveling.

### BACKGROUND

The matters described in this Background section are only for enhancement of understanding of the background of the disclosure, and should not be taken as acknowledgment that they correspond to prior art already known to those skilled in the art.

Damage due to vehicle collisions is increasing as the number of vehicles increases. In particular, the mortality rate of pedestrians is high if a vehicle collides with a pedestrian.

To reduce such damage, a technology for controlling the speed of a vehicle even by detecting the presence or absence of the obstacle in front of the vehicle and the type of the obstacle using a radar sensor, a LiDAR sensor, a camera sensor, or the like installed on the vehicle if a driver is unaware of an obstacle in front of the vehicle is actively being developed.

In relation to this, there is a need to detect a pedestrian on a sidewalk close to a road on which a vehicle is traveling in advance and to appropriately control the speed of the vehicle to minimize the risk of collision according to the movement of the pedestrian.

### SUMMARY

According to the present disclosure, an apparatus for controlling a vehicle, the apparatus may comprise a memory configured to store a parameter associated with speed-based distance adjustment, and a processor, by executing program instructions, configured to determine, based on the parameter and a speed of the vehicle, at least one distance between the vehicle and at least one target, wherein the at least one distance is a varying distance based on the speed of the vehicle, identify, based on the at least one distance, a risk area among a plurality of risk areas, wherein at the least one target is located in the risk area, wherein the plurality of risk areas are generated by dividing a sidewalk into a plurality of areas, and wherein the sidewalk is within a threshold distance from a road on which the vehicle is traveling, determine a start point of a segment associated with the risk area and determine an end point of the segment associated with the risk area, wherein a target speed is set for the risk area, and control the speed of the vehicle from the start point such that the speed of the vehicle reaches the target speed at the end point.

The apparatus, wherein the processor is configured to divide the sidewalk into the plurality of areas based on at least one of, the speed of the vehicle, a distance detected by a sensor, a predetermined longitudinal distance from the vehicle, a predetermined lateral distance from the vehicle, or a predetermined parameter corresponding to the speed of the vehicle.

The apparatus, wherein the processor is configured to determine the start point and the end point based on at least one of, the speed of the vehicle a longitudinal speed of the at least one target, or a predetermined parameter corresponding to the longitudinal speed of the at least one target.

The apparatus, wherein the processor is configured to perform at least one of, identifying a longitudinal distance of the risk area, wherein the longitudinal distance is a greater of the longitudinal distance from the vehicle and the distance detected by the sensor, identifying a first risk area among the plurality of risk areas, based on a point separated from the vehicle by the longitudinal distance of the risk area and a first point laterally separated from the vehicle by a first distance, identifying a second risk area among the plurality of risk areas, based on the point and a second point separated from the first point by a second distance, identifying a third risk area among the plurality of risk areas, based on the point and a third point separated from the second point by a third distance, or identifying a fourth risk area among the plurality of risk areas, wherein the fourth risk area is a remaining area after excluding the first to third risk areas from the plurality of risk areas.

The apparatus, wherein the processor is configured to determine the plurality of risk areas, wherein boundaries of the plurality of risk areas expand as the speed of the vehicle increases.

The apparatus, wherein the processor is configured to divide at least one risk area of the plurality of risk areas into, a first risk segment that is within a specific longitudinal distance from the vehicle, and a second risk segment that is outside the specific longitudinal distance from the vehicle, and wherein a width of the at least one risk area in the second risk segment becomes narrower as the at least one risk area is farther away from the vehicle.

The apparatus, wherein the processor is configured to determine the target speed for the at least one target based on a distance separating the at least one target laterally from the vehicle and based on the risk area in which the at least one target is located.

The apparatus, wherein the processor is configured to determine the start point based on the predetermined parameter and the speed of the vehicle.

The apparatus, wherein the processor is configured to calibrate the predetermined parameter based on at least one of, a first weight according to a lateral speed of the at least one target, or a second weight according to the risk area, and determine the start point based on the calibrated parameter.

The apparatus, wherein the processor is configured to control an acceleration of the vehicle such that a rate of change in the acceleration of the vehicle is less than a rate of change in a deceleration of the vehicle, thereby enabling control of the speed of the vehicle from the start point so that the speed of the vehicle reaches the target speed at the end point.

The apparatus, wherein the processor is configured to, based on detecting a plurality of targets within the plurality of risk areas, determine at least one of, a plurality of target speeds for the plurality of targets, wherein each of the plurality of targets corresponds to a respective one of the plurality of target speeds, a plurality of start points for the plurality of targets, wherein each of the plurality of targets corresponds to a respective one of the plurality of start points, or a plurality of end points for the plurality of targets, wherein each of the plurality of targets corresponds to a respective one of the plurality of end points, and control the speed of the vehicle from a start point among the plurality of start points, wherein the start point is a point closest to the vehicle.

The apparatus, wherein the processor is configured to control the speed of the vehicle such that the speed of the vehicle reaches a slower target speed between an n-th target speed associated with an n-th target and an (n+1)-th target speed associated with an (n+1)-th target, based on a start point associated with the (n+1)-th target being closer to a current location of the vehicle than an end point associated with the n-th target, and wherein the “n” is a natural number.

The apparatus, wherein the processor is configured to control the speed of the vehicle such that the speed of the vehicle is maintained at the target speed until the vehicle reaches a point at which the at least one target is located relative to the end point, and control the speed of the vehicle such that the speed of the vehicle reaches a speed different from the target speed after the vehicle has passed the point at which the at least one target is located.

The apparatus, wherein the parameter may comprise a Time-Gap parameter expressed in units of time.

According to the present disclosure, a method performed by an apparatus for controlling a vehicle, the method may comprise determining a risk area among a plurality of risk areas, wherein at least one target is located in the risk area, wherein the plurality of risk areas are generated by dividing a sidewalk into a plurality of areas, and wherein the sidewalk is within a threshold distance from a road on which the vehicle is travelling, determining a start point of a segment associated with the risk area and determining an end point of the segment associated with the risk area, wherein a target speed is set for the risk area, and controlling a speed of the vehicle from the start point such that the speed of the vehicle reaches the target speed at the end point.

The method, wherein the dividing the sidewalk may comprise dividing the sidewalk into the plurality of areas based on at least one of, the speed of the vehicle, a distance detected by a sensor, a predetermined longitudinal distance from the vehicle, a predetermined lateral distance from the vehicle, or a predetermined parameter corresponding to the speed of the vehicle.

The method, wherein the determining the start point may comprise determining the start point based on at least one of the speed of the vehicle, a longitudinal speed of the at least one target, or a predetermined parameter corresponding to the longitudinal speed of the at least one target.

The method, wherein the dividing the sidewalk may comprise identifying a longitudinal distance of the risk area, wherein the longitudinal distance is a greater of the longitudinal distance from the vehicle and the distance detected by the sensor.

The method, wherein the dividing the sidewalk may comprise dividing at least one risk area of the plurality of risk areas into, a first risk segment that is within a specific longitudinal distance from the vehicle, and a second risk segment that is outside the specific longitudinal distance from the vehicle, and wherein a width of the at least one risk area in the second risk segment becomes narrower as the at least one risk area is farther away from the vehicle.

The method, wherein the determining the start point may comprise determining, based on detecting a plurality of targets within the plurality of risk areas, at least one of, a plurality of target speeds for the plurality of targets, wherein each of the plurality of targets corresponds to a respective one of the plurality of target speeds, a plurality of start points for the plurality of targets, wherein each of the plurality of targets corresponds to a respective one of the plurality of start points, or a plurality of end points for the plurality of targets, wherein each of the plurality of targets corresponds to a respective one of the plurality of end points, and wherein the controlling the speed of the vehicle may comprise controlling the speed of the vehicle from a start point among the plurality of start points, and wherein the start point is a point closest to the vehicle.

### BRIEF DESCRIPTION OF THE DRAWINGS

The above and other objects, features and advantages of the present disclosure will be more apparent from the following detailed description taken in conjunction with the accompanying drawings:

FIG. 1 shows an example of a vehicle control apparatus according to an example of the present disclosure;

FIG. 2 shows an example of a process of processing data in a vehicle control apparatus according to ab example of the present disclosure;

FIG. 3 shows an example of distinguishing a plurality of risk areas in a vehicle control apparatus according to an example of the present disclosure;

FIG. 4 shows an example in which a vehicle control apparatus according to an example of the present disclosure sets different target speeds for risk areas;

FIG. 5 shows an example of determining a start point for a segment in which a speed of a vehicle is controlled to a target speed, and an end point for a segment in which the speed of the vehicle is controlled to the target speed in a vehicle control apparatus according to an example of the present disclosure;

FIG. 6 shows an example of a plurality of segments in which the speed of a vehicle is controlled differently based on detection of a plurality of targets in a vehicle control apparatus according to an example of the present disclosure;

FIG. 7 shows an example of a vehicle control apparatus or a vehicle control method according to an example of the present disclosure;

FIG. 8 shows an example of a process of controlling the speed of a vehicle based on the detection of a plurality of targets by a vehicle control apparatus or a vehicle control method according to an example of the present disclosure; and

FIG. 9 shows an example of a computing system related to a vehicle control apparatus or a vehicle control method according to an example of the present disclosure.

### DETAILED DESCRIPTION

Hereinafter, some examples of the present disclosure will be described in detail with reference to the exemplary drawings. In adding the reference numerals to the components of each drawing, it should be noted that the identical or equivalent component is designated by the identical numeral even if they are displayed on other drawings. Further, in describing the example of the present disclosure, a detailed description of well-known features or functions will be ruled out in order not to unnecessarily obscure the gist of the present disclosure.

In describing the components of the example according to the present disclosure, terms such as first, second, “A”, “B”, (a), (b), and the like may be used. These terms are merely intended to distinguish one component from another component, and the terms do not limit the nature, sequence or order of the constituent components. In addition, expression such as “at least one of A, B, or C, or any combination thereof” may include A or B or C or a combination thereof such as AB or ABC and/or the like.

For purposes of this application and the claims, using the exemplary phrase “at least one of: A; B; or C” or “at least one of A, B, or C,” the phrase means “at least one A, or at least one B, or at least one C, or any combination of at least one A, at least one B, and at least one C. Further, exemplary phrases, such as “A, B, and C”, “A, B, or C”, “at least one of A, B, and C”, “at least one of A, B, or C”, etc. as used herein may mean each listed item or all possible combinations of the listed items. For example, “at least one of A or B” may refer to (1) at least one A; (2) at least one B; or (3) at least one A and at least one B.

Unless otherwise defined, all terms used herein, including technical or scientific terms, have the same meanings as those generally understood by those skilled in the art to which the present disclosure pertains. Such terms as those defined in a generally used dictionary are to be interpreted as having meanings equal to the contextual meanings in the relevant field of art, and are not to be interpreted as having ideal or excessively formal meanings unless clearly defined as having such in the present application.

An automation level of an autonomous driving vehicle may be classified as follows, according to the American Society of Automotive Engineers (SAE). At autonomous driving level 0, the SAE classification standard may correspond to “no automation,” in which an autonomous driving system is temporarily involved in emergency situations (e.g., automatic emergency braking) and/or provides warnings only (e.g., blind spot warning, lane departure warning, etc.), and a driver is expected to operate the vehicle. At autonomous driving level 1, the SAE classification standard may correspond to “driver assistance,” in which the system performs some driving functions (e.g., steering, acceleration, brake, lane centering, adaptive cruise control, etc.) while the driver operates the vehicle in a normal operation section, and the driver is expected to determine an operation state and/or timing of the system, perform other driving functions, and cope with (e.g., resolve) emergency situations. At autonomous driving level 2, the SAE classification standard may correspond to “partial automation,” in which the system performs steering, acceleration, and/or braking under the supervision of the driver, and the driver is expected to determine an operation state and/or timing of the system, perform other driving functions, and cope with (e.g., resolve) emergency situations. At autonomous driving level 3, the SAE classification standard may correspond to “conditional automation,” in which the system drives the vehicle (e.g., performs driving functions such as steering, acceleration, and/or braking) under limited conditions but transfer driving control to the driver when the required conditions are not met, and the driver is expected to determine an operation state and/or timing of the system, and take over control in emergency situations but do not otherwise operate the vehicle (e.g., steer, accelerate, and/or brake). At autonomous driving level 4, the SAE classification standard may correspond to “high automation,” in which the system performs all driving functions, and the driver is expected to take control of the vehicle only in emergency situations. At autonomous driving level 5, the SAE classification standard may correspond to “full automation,” in which the system performs full driving functions without any aid from the driver including in emergency situations, and the driver is not expected to perform any driving functions other than determining the operating state of the system. Although the present disclosure may apply the SAE classification standard for autonomous driving classification, other classification methods and/or algorithms may be used in one or more configurations described herein.

One or more features associated with autonomous driving control may be activated based on configured autonomous driving control setting(s) (e.g., based on at least one of: an autonomous driving classification, a selection of an autonomous driving level for a vehicle, etc.). Based on one or more features (e.g., features of a risk area based speed control) described herein, an operation of the vehicle may be controlled. The vehicle control may include various operational controls associated with the vehicle (e.g., autonomous driving control, sensor control, braking control, braking time control, acceleration control, acceleration change rate control, alarm timing control, forward collision warning time control, etc.).

One or more auxiliary devices (e.g., engine brake, exhaust brake, hydraulic retarder, electric retarder, regenerative brake, etc.) may also be controlled, for example, based on one or more features (e.g., features of a risk area based speed control) described herein.

One or more communication devices (e.g., a modem, a network adapter, a radio transceiver, an antenna, etc., that is capable of communicating via one or more wired or wireless communication protocols, such as Ethernet, Wi-Fi, near-field communication (NFC), Bluetooth, Long-Term Evolution (LTE), 5G New Radio (NR), vehicle-to-everything (V2X), etc.) may also be controlled, for example, based on one or more features (e.g., features of a risk area based speed control) described herein.

Minimum risk maneuver (MRM) operation(s) may also be controlled, for example, based on one or more features (e.g., features of a risk area based speed control) described herein. A minimal risk maneuvering operation (e.g., a minimal risk maneuver, a minimum risk maneuver) may be a maneuvering operation of a vehicle to minimize (e.g., reduce) a risk of collision with surrounding vehicles in order to reach a lowered (e.g., minimum) risk state. A minimal risk maneuver may be an operation that may be activated during autonomous driving of the vehicle when a driver is unable to respond to a request to intervene. During the minimal risk maneuver, one or more processors of the vehicle may control a driving operation of the vehicle for a set period of time.

Biased driving operation(s) may also be controlled, for example, based on one or more features (e.g., features of a risk area based speed control) described herein. A driving control apparatus may perform a biased driving control. To perform a biased driving, the driving control apparatus may control the vehicle to drive in a lane by maintaining a lateral distance between the position of the center of the vehicle and the center of the lane. For example, the driving control apparatus may control the vehicle to stay in the lane but not in the center of the lane. The driving control apparatus may identify or determine a biased target lateral distance for biased driving control. For example, a biased target lateral distance may comprise an intentionally adjusted lateral distance that a vehicle may aim to maintain from a reference point, such as the center of a lane or another vehicle, during maneuvers such as lane changes. This adjustment may be made to improve the vehicle's stability, safety, and/or performance under varying driving conditions, etc. For example, during a lane change, the driving control system may bias the lateral distance to keep a safer gap from adjacent vehicles, considering factors such as the vehicle's speed, road conditions, and/or the presence of obstacles, etc.

One or more sensors (e.g., IMU sensors, camera, LIDAR, RADAR, blind spot monitoring sensor, line departure warning sensor, parking sensor, light sensor, rain sensor, traction control sensor, anti-lock braking system sensor, tire pressure monitoring sensor, seatbelt sensor, airbag sensor, fuel sensor, emission sensor, throttle position sensor, inverter, converter, motor controller, power distribution unit, high-voltage wiring and connectors, auxiliary power modules, charging interface, etc.) may also be controlled, for example, based on one or more features (e.g., features of a risk area based speed control) described herein. An operation control for autonomous driving of the vehicle may include various driving control of the vehicle by the vehicle control device (e.g., acceleration, deceleration, steering control, gear shifting control, braking system control, traction control, stability control, cruise control, lane keeping assist control, collision avoidance system control, emergency brake assistance control, traffic sign recognition control, adaptive headlight control, etc.).

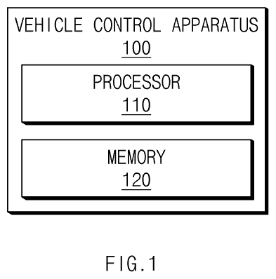

Hereinafter, examples of the present disclosure will be described in detail with reference to FIGS. 1 to 9.

FIG. 1 shows an example of a vehicle control apparatus according to an example of the present disclosure;

Referring to FIG. 1, a vehicle control apparatus 100 according to an example of the present disclosure may be implemented inside a vehicle. In this case, the vehicle control apparatus 100 may be integrally formed with internal control units of the vehicle, or may be implemented as a separate device and connected to the control units of the vehicle by a separate connection element.

According to an example, the vehicle control apparatus 100 may include a processor 110 and a memory 120. The configuration of the vehicle control apparatus 100 shown in FIG. 1 is exemplary, and examples of the present disclosure are not limited thereto. For example, the vehicle control apparatus 100 may further include components not shown in FIG. 1.

According to an example, the memory 120 may store commands or data. For example, the memory 120 may include one instruction or two or more instructions that cause the vehicle control apparatus 100 to perform various operations if executed by the processor 110.

According to an example, the memory 120 may be implemented as a single chipset with the processor 110, and may store a variety of information related to the vehicle control apparatus 100. For example, the memory 120 may store information regarding a history of operations of the processor 110.

According to an example, the memory 120 may include non-volatile memory (Read Only Memory: ROM) and volatile memory (Random Access Memory: RAM). For example, the memory 120 may store information about a first Time-gap parameter predetermined according to the speed of the vehicle, a second Time-gap parameter predetermined according to the speed of the target in the longitudinal direction, or the like. A Time-Gap parameter may represent a time interval (in seconds) that should be maintained between a vehicle and a target ahead. This parameter may be used in adaptive cruise control (ACC) and autonomous driving systems to dynamically adjust a distance between the vehicle and the target based on the vehicle's speed. If a Time-Gap parameter is set to 2 seconds, this means the vehicle should stay at a distance that would take it 2 seconds to cover if the vehicle maintained its current speed. This distance may change with speed of the vehicle. For example, at 50 km/h, a 2-second time gap would correspond to about 27.8 meters (Distance=Speed×Time-Gap).

According to an example, the memory 120 may store a parameter used to determine a distance that varies depending on the speed. For example, the parameter includes a Time-Gap parameter in units of time. For example, the Time-Gap parameter includes a first Time-Gap parameter predetermined corresponding to a speed of the vehicle or a second Time-Gap parameter predetermined corresponding to a longitudinal speed of the target. For example, the Time-gap parameter may be used to determine a distance. As a specific example, a distance may be determined based on a value obtained by multiplying the Time-gap parameter by the speed.

According to an example, the Time-gap parameter may include a time value set corresponding to a specific speed. As a specific example, the Time-gap parameter corresponding to a speed of 3 m/s may be set to 1.5 seconds, the Time-gap parameter corresponding to a speed of 0 m/s may be set to 2.5 seconds, and the Time-gap parameter corresponding to a speed of −3 m/s may be set to 3.5 seconds.

According to an example, the processor 110 may identify or determine a risk area in which at least one target is located, among a plurality of risk areas generated by dividing a sidewalk adjacent to a road, on which a vehicle is traveling, into a plurality of areas. A risk area may refer to a spatial zone around a vehicle and may be used to assess the presence and movement of potential hazards, such as pedestrians, obstacles, or other vehicles. This area is dynamically determined based on factors like the vehicle's speed, distance to potential targets, and environmental conditions. The size and shape of the risk area may depend on both longitudinal (forward/backward) and lateral (side-to-side) distances from the vehicle and adjust in real time based on factors like vehicle speed and target behavior. At higher speeds, the risk area may expand to provide more reaction time, while at lower speeds, the risk area may contract as less reaction time is required. The risk area may be divided into multiple segments or zones, each associated with varying levels of risk (e.g., safe, caution, high risk) depending on a proximity and behavior of detected objects within those zones. This segmentation may allow the vehicle to prioritize responses, such as adjusting speed, steering, or maintaining safe distances. By evaluating its surroundings through the risk area, the vehicle may navigate safely and efficiently, enabling collision avoidance and autonomous control systems.

According to an example, the processor 110 may divide a sidewalk adjacent to a road on which a vehicle is traveling into a plurality of risk areas based on at least one of a speed of the vehicle, a distance detected by a sensor, a predetermined longitudinal distance from the vehicle, a predetermined lateral distance from the vehicle, or a first Time-gap parameter predetermined corresponding to the speed of the vehicle, or any combination thereof.

In an example, the sidewalk is a roadway intended for use by pedestrian traffic and may include a sidewalk on which pedestrians walk.

In an example, a sidewalk close to a road on which a vehicle is traveling may vary depending on the direction of a lane in which the vehicle is traveling. For example, in a road in which a vehicle is traveling in the right lane, the sidewalk may be located on the right side of the vehicle. Conversely, in a road in which a vehicle is traveling in the left lane, the sidewalk may be located on the left side of the vehicle.

In an example, the sensor may include one or more sensors. For example, the sensors may be attached to different locations on the vehicle. The sensors may face one or more different directions. For example, the sensor may be attached to the front, sides, rear or roof of the vehicle to face directions such as a forward-facing direction, a rear-facing direction, a side-facing direction, and/or the like.

In an example, the sensor may be an image sensor, such as a high dynamic range camera. For example, the sensor may include a non-visual sensor. For example, the sensor may include a RADAR, a light detection and ranging (LiDAR), or an ultrasonic sensor in addition to the image sensor.

In an example, the sensor may detect an object present in front of the vehicle. For example, the distance detected by the sensor may include the maximum distance that the sensor is able to detect toward the front of the vehicle.

In an example, a predetermined longitudinal distance from the vehicle may include a distance in the front direction of the vehicle. That is, the predetermined longitudinal distance from the vehicle may include a distance in the same direction as the traveling direction of the vehicle. For example, the predetermined longitudinal distance from the vehicle may include a distance measured from the front end of the vehicle toward the front.

In an example, the predetermined longitudinal distance from the vehicle may be smaller than the distance that is detectable by the sensor. For example, the predetermined longitudinal distance from the vehicle may be set within the distance in which the sensor is able to detect an object present in front of the vehicle.

In an example, the predetermined lateral distance from the vehicle may include a distance in the side direction of the vehicle. That is, the predetermined lateral distance from the vehicle may include a distance in a direction perpendicular to the traveling direction of the vehicle.

For example, the predetermined lateral distance from the vehicle may include a distance measured from the right end of the vehicle toward the right direction. Alternatively, the predetermined lateral distance from the vehicle may include a distance measured from the left end of the vehicle toward the left direction.

In this case, the lateral direction may refer to a direction from the vehicle toward a sidewalk close to the vehicle. For example, if the sidewalk is located on the right side of the vehicle, the lateral direction may refer to a direction from the vehicle toward the right.

According to an example, the first Time-gap parameter predetermined corresponding to the speed of the vehicle may include a Time-gap parameter set corresponding to the speed of the vehicle. For example, the Time-gap parameter may vary according to a change in the speed of the vehicle.

According to an example, the processor 110 may divide a sidewalk close to a road, on which a vehicle is traveling, into a plurality of risk areas.

According to an example, the processor 110 may divide the plurality of risk areas into a first risk area, a second risk area, a third risk area, and a fourth risk area in the order of proximity to the vehicle.

For example, the risk area closest to the vehicle may be set as the first risk area, the second closest as the second risk area, the third closest as the third risk area, and the furthest from the vehicle as the fourth risk area. However, this is only an example, and the number of risk areas divided by the processor 110 may vary depending on system settings, user settings, vehicle traveling conditions, road conditions, or the like.

According to an example, the range of the plurality of risk areas may be specified based on the longitudinal distance of the risk area and the lateral distance of the risk area. In this case, the longitudinal direction and the lateral direction may be determined according to the traveling direction of the vehicle, and the direction identical to the traveling direction of the vehicle may be determined as the longitudinal direction, and the direction perpendicular to the traveling direction of the vehicle may be determined as the lateral direction. For example, the plurality of risk areas may be specified as areas having a horizontal length equal to the longitudinal distance and a vertical length equal to the lateral distance.

According to an example, the plurality of risk areas may have the same longitudinal distance from each other. On the other hand, the plurality of risk areas may have different lateral distances from each other. Accordingly, the plurality of risk areas may be distinguished according to the lateral distance.

According to an example, the processor 110 may identify or determine a larger distance between a predetermined longitudinal distance from the vehicle and a distance detected by a sensor as the longitudinal distance of the risk area.

According to an example, the processor 110 may identify a point that is located at a longitudinal distance “r” of the risk area from the vehicle. The processor 110 may identify a first point which is laterally separated from the vehicle by a first distance “c”.

According to an example, the first distance “c” may vary depending on the speed of the vehicle. For example, the processor 110 may determine the first distance “c” based on the speed of the vehicle and the first Time-gap parameter predetermined corresponding to the speed of the vehicle.

Specifically, the first distance “c” may be determined based on the product of the speed of the vehicle and the first Time-gap parameter in time units. Accordingly, the first distance “c” may increase as the speed of the vehicle increases.

According to an example, the processor 110 may identify the first risk area based on the location (0,0) of the vehicle, a point (0,r) that is longitudinally separated from the vehicle by the longitudinal distance “r” of the risk area, a first point (c,0) that is laterally separated from the vehicle by the first distance “c”, and a point (c,r) that is longitudinally separated from the first point (c,0) by the longitudinal distance “r” of the risk area.

For example, the first risk area may be identified as an area having a vertical length equal to the longitudinal distance “r” of the risk area and a horizontal length equal to the first distance “c”.

According to an example, the processor 110 may identify a second point which is separated from the first point by a second distance.

According to an example, the second distance “d” may vary depending on the speed of the vehicle. For example, the processor 110 may determine the second distance “d” based on the speed of the vehicle and the first Time-gap parameter predetermined corresponding to the speed of the vehicle.

Specifically, the second distance “d” may be determined based on the product of the speed of the vehicle and the first Time-gap parameter in time units. Accordingly, the second distance “d” may increase as the speed of the vehicle increases.

According to an example, the processor 110 may identify a second risk area based on the first point (c,0), the point (c,r) that is longitudinally separated from the first point (c,0) by the longitudinal distance “r” of the risk area, a second point (c+d,0) that is laterally separated from the first point (c,0) by the second distance “d”, and a point (c+d,r) that is longitudinally separated from the second point (c+d,0) by the longitudinal distance “r” of the risk area.

For example, the second risk area may be identified as an area having a vertical length equal to the longitudinal distance “r” of the risk area and a horizontal length equal to the second distance “d”.

According to an example, the processor 110 may identify a third point that is separated from the second point by a third distance “e”.

According to an example, the third distance “e” may vary depending on the speed of the vehicle. For example, the processor 110 may determine the third distance “e” based on the speed of the vehicle and the first Time-gap parameter predetermined corresponding to the speed of the vehicle.

Specifically, the third distance “e” may be determined based on the product of the speed of the vehicle and the first Time-gap parameter in time units. Accordingly, the third distance “e” may increase as the speed of the vehicle increases.

According to an example, the processor 110 may identify a third risk area based on the second point (c+d,0), the point (c+d,r) that is separated from the second point (c+d,0) by the longitudinal distance “r” of the risk area, a third point (c+d+e,0) that is laterally separated from the second point (c+d,0) by the third distance “e”, and a point (c+d+e,r) that is separated from the third point (c+d+e,0) by the longitudinal distance “r” of the risk area.

For example, the third risk area may be identified as an area having a vertical length equal to the longitudinal distance “r” of the risk area and a horizontal length equal to the third distance “e”.

According to an example, the processor 110 may identify the remaining area except the first to third risk areas among the plurality of areas as the fourth risk area.

According to an example, the first to third distances may be determined based on a vehicle speed and the first Time-gap parameter in time units, and thus, the processor 110 may identify the plurality of risk areas that are wider as the vehicle speed increases. In other words, the width of the plurality of risk areas may increase as the vehicle speed increases.

For example, the fourth risk area may be identified as an area located at a longer distance from the vehicle in the lateral direction than the first to third risk areas.

According to an example, the first Time-gap parameter used to determine the first distance, the second distance, or the third distance may be set to the same value or may be set to different values.

According to an example, the processor 110 may identify a risk area which at least one target is located, among the plurality of risk areas. For example, the processor 110 may detect a target present on a sidewalk located in front of the vehicle and identify in which risk area the identified target is located.

According to an example, the processor 110 may control the speed of the vehicle to a target speed set for each risk area. For example, the processor 110 may identify a risk area in which the target is located and control the speed of the vehicle such that the speed of the vehicle reaches the target speed according to a corresponding risk area.

According to an example, the target speed may be set differently according to the risk area. For example, the target speed may be lower as the target is located in an area in which there is a higher risk of collision with the vehicle.

As a specific example, the target speed in the first risk area may be set to a range between 0% of the current speed of the vehicle and 20% of the current speed of the vehicle. The target speed in the second risk area may be set to a range between 20% of the current speed of the vehicle and 50% of the current speed of the vehicle. The target speed in the third risk area may be set to a range between 50% of the current speed of the vehicle and 100% of the current speed of the vehicle. The target speed in the fourth risk area may be set to the same speed as the current speed of the vehicle. It should be noted that this is only an example, and the target speed may be set differently according to systems, a user, traveling environment, road environment, or the like.

According to an example, the processor 110 may generate a profile using information on a target speed for each risk area. The processor 110 may store a generated profile in the memory 120.

As another example, the processor 110 may obtain information on the target speed for each risk area from an external server.

According to an example, the processor 110 may determine a start point of a segment in which the speed of the vehicle is controlled to a target speed set for each risk area, and an end point of a segment in which the speed of the vehicle is controlled to a target speed, based on at least one of the speed of the vehicle, the longitudinal speed of a target, or the second Time-gap parameter predetermined corresponding to the longitudinal speed of the target, or any combination thereof.

According to an example, the processor 110 may determine the speed of the target. For example, a sensor mounted on the vehicle may detect information related to the movement of the target, and the processor 110 may determine the speed of the target based on the information related to the movement of the target.

According to an example, the processor 110 may determine a speed at which the target moves in the longitudinal direction. In this case, a speed if the target moves in a direction closer to the vehicle may have a different sign from a speed if the target moves in a direction away from the vehicle. For example, the speed if the target moves in a direction closer to the vehicle may have a negative sign, and the speed if the target moves in a direction away from the target may have a positive sign.

According to an example, the processor 110 may determine the second Time-gap parameter that is predetermined corresponding to the longitudinal speed of the target. The second Time-gap parameter may be set in consideration of a range in which the speed of the target is able to change.

For example, the second Time-gap parameter may be set to a larger value as the target moves in the longitudinal direction closer to the vehicle. In addition, the second Time-gap parameter may be set to a larger value as the longitudinal speed of the target increases.

According to an example, the first Time-gap parameter predetermined corresponding to the speed of the vehicle and the second Time-gap parameter predetermined corresponding to the longitudinal speed of the target may be set independently of each other. As a specific example, in spite of the same speed value, the first Time-gap parameter and the second Time-gap parameter may be set to different values.

According to an example, the unit of speed corresponding to the first Time-gap parameter and the unit of speed corresponding to the second Time-gap parameter may be different. For example, while the unit of speed corresponding to the first Time-gap parameter may be km/h, the unit of speed corresponding to the second Time-gap parameter may be m/s.

According to an example, the distinction between the first Time-gap parameter and the second Time-gap parameter is for determining whether the first Time-gap parameter and the second Time-gap parameter correspond to the speed of the vehicle or the speed of the target, and the specific values of the Time-gap parameters may vary according to a speed. For example, the value of the first Time-gap parameter corresponding to the speed of the vehicle of 50 km/h and the value of the first Time-gap parameter corresponding to the speed of the vehicle of 100 km/h may be set to different values.

According to an example, the processor 110 may determine a target speed for the target based on the distance that the target is laterally separated from the vehicle and a risk area in which the target is located.

For example, the processor 110 may identify a risk area in which a target is located and identify a target speed according to a corresponding risk area. In addition, the processor 110 may determine the start point and the end point of a segment in which the speed of the vehicle is controlled to the target speed to identify the segment for controlling the speed of the vehicle to the target speed.

According to an example, the processor 110 may determine the start point based on the second Time-gap parameter and the speed of the vehicle. Specifically, the processor 110 may determine a distance related to the start point based on the product of the second Time-gap parameter and the speed of the vehicle. Further, the processor 110 may determine, as a start point, a point which is separated from the target by the distance related to the start point, in a direction toward the vehicle. For example, if the distance determined by multiplying the second Time-gap parameter by the vehicle's speed is 3 km, the processor 110 may determine, as the start point, a point separated from the target in a direction toward the vehicle by 3 km.

According to an example, the processor 110 may calibrate the second Time-gap parameter by applying at least one of a first weight according to the lateral speed of the target, or a second weight according to the risk area, or any combination thereof to the second Time-gap parameter, and determine the start point based on the calibrated second Time-gap parameter.

The processor 110 may identify a lateral speed of the target and apply the first weight according to the identified speed to the second Time-gap parameter. The first weight according to the lateral speed of the target may include a gain value set according to the lateral speed of the target.

For example, the first weight may be set to a larger value as the target moves laterally closer to the vehicle. In addition, the first weight may be set to a larger value as the lateral speed of the target increases.

According to an example, the processor 110 may determine whether the target is moving laterally away from the vehicle or moving laterally closer to the vehicle via the sign of the lateral speed of the target.

The processor 110 may identify a risk area in which the target is located and apply a second weight according to the identified risk area to the second Time-gap parameter. In this case, the second weight according to the identified risk area may be set to a larger value as the risk area has a higher risk of collision between the target and the vehicle. For example, the second weight according to the first risk area may be higher than the weight according to the second risk area.

The second weight according to the risk area may include a gain value set according to the risk area in which the target exists. As a specific example, the second weight of the first risk area may be set to 1, the second weight of the second risk area may be set to 0.9, and the second weight of the third risk area may be set to 0.8. In addition, the processor 110 may not apply the second weight to the second Time-gap parameter if the target is located in the fourth risk area.

According to an example, the processor 110 may calibrate the second Time-gap parameter by applying only the first weight to the second Time-gap parameter, applying only the second weight to the second Time-gap parameter, or applying both the first weight and the second weight to the second Time-gap parameter.

According to an example, the processor 110 may determine the start point of a segment in which the speed of the vehicle is controlled to the target speed based on the calibrated second Time-gap parameter. For example, the start point may be determined based on the product of the calibrated second Time-gap parameter and the speed of the vehicle.

According to an example, the processor 110 may determine the end point of the segment in which the speed of the vehicle is controlled to the target speed based on the longitudinal speed of the target and the Time-gap parameter according to the longitudinal speed of the target. In this case, the Time-gap parameter used to determine the end point may include the second Time-gap parameter according to the longitudinal speed of the target.

According to an example, the processor 110 may determine a distance related to the end point based on the product of the second Time-gap parameter according to the longitudinal speed of the target and the longitudinal speed of the target. The processor 110 may then determine, as the end point, a point which is separated from the target by the distance related to the end point, in a direction toward the vehicle. For example, if the distance determined based on the product of the second Time-gap parameter and the longitudinal speed of the target is 500 m, the processor 110 may determine, as the end point, a point which is separated from the target by 500 m in a direction toward the vehicle.

According to an example, the processor 110 may determine whether the target is moving longitudinally away from the vehicle or moving longitudinally closer to the vehicle via the sign of the longitudinal speed of the target. Further, the processor 110 may determine the end point by considering the sign of the longitudinal speed of the target.

For example, if the target moves away from the vehicle, the longitudinal speed of the target may have a positive sign (+), and if the target moves toward the vehicle, the longitudinal speed of the target may have a negative sign (−).

According to an example, the processor 110 may determine the end point based on a predetermined distance value for the end point. For example, the predetermined distance value for the end point may be set to a minimum distance at which the target and the vehicle do not collide. As a specific example, the predetermined distance value for the end point may be set to 3 m.

According to an example, the processor 110 may determine the end point based on a smaller value among a value determined based on the second Time-gap parameter according to the longitudinal speed of the target and the longitudinal speed of the target and the predetermined distance value for the end point.

For example, if the value determined based on the second Time-gap parameter according to the longitudinal speed of the target and the longitudinal speed of the target is 5 m, and the predetermined distance value for the end point is 3 m, the processor 110 may determine, as the end point, a point separated from the target by 3 m in the direction toward the vehicle.

According to an example, the processor 110 may control the speed of the vehicle from the start point such that the speed of the vehicle reaches the target speed at the end point.

According to an example, the processor 110 may start controlling the speed of the vehicle from the start point of a corresponding segment and then control the speed of the vehicle to reach the target speed at the end point of the corresponding segment.

For example, if the current speed of the vehicle is 100 km/h and the target speed is 50 km/h, the processor 110 may reduce the speed of the vehicle from the time the vehicle passes the start point such that the speed of the vehicle is to reach 50 km/h if the vehicle reaches the end point. That is, the processor 110 may gradually reduce the speed of the vehicle from the start point until the vehicle reaches the end point. Accordingly, the speed of the vehicle may travel at the target speed before reaching the end point.

According to an example, the processor 110 may set an upper limit value of the target speed and a lower limit value of the target speed.

For example, the lower limit value of the target speed may be set to a target speed within the tolerable range of the target speed. As a specific example, if the tolerable range of the target speed is 1 km/h and the target speed is 50 km/h, the processor 110 may control the speed of the vehicle such that the speed of the vehicle reaches at least 49 km/h at the end point.

In addition, for example, the upper limit value of the target speed may be set to a speed limit of the road on which the vehicle is traveling. As a specific example, if the speed limit of the road is 30 km/h in spite of the target speed of 50 km/h, the processor 110 may control the speed of the vehicle such that the speed of the vehicle does not exceed 30 km/h at the end point.

According to an example, the processor 110 may divide at least one of the plurality of risk areas into a first risk segment “a” within a specific longitudinal distance from the vehicle, and a second risk segment “b” outside the specific longitudinal distance from the vehicle.

For example, if the target is located in the second risk segment “b” outside the specific longitudinal distance from the vehicle, a sufficient distance may be secured between the target and the vehicle, thus reducing the risk of collision between the target and the vehicle. Accordingly, the range of the risk area of the second risk segment “b” may need to be adjusted based on a reduction in the risk of collision between the target and the vehicle. As a specific example, even if a plurality of targets present in the second risk segment “b” are all at the same distance from the vehicle in the lateral direction, the target that is further from the vehicle in the longitudinal direction may be identified as being located in a risk area with a lower risk level.

According to an example, the specific distance separating the first risk segment “a” and the second risk segment “b” may be set based on the speed of the vehicle and a first Time-gap parameter predetermined corresponding to the speed of the vehicle. For example, the specific distance separating the first risk segment “a” and the second risk segment “b” may be set based on a value obtained by multiplying the vehicle speed by the first Time-gap parameter. Accordingly, the first risk segment “a” may become longer as the speed of the vehicle increases.

According to an example, the width of at least one risk area in the second risk segment “b” may become narrower as it is further away from the vehicle.

For example, the processor 110 may identify a risk area that is closest to the vehicle among a plurality of risk areas of which widths become narrower as they are further away from the vehicle. In addition, the processor 110 may identify a point within the risk area, which is the farthest in the longitudinal direction from the vehicle and the closest in the lateral direction from the vehicle, as a point in which the width of the risk area converges to 0, among points within the corresponding risk area. The point in which the width of the risk area converges to 0 may be located at the maximum distance that a sensor mounted on the vehicle is able to detect.

For example, among the plurality of risk areas, the first risk area closest to the vehicle may not have its risk area width that becomes narrower even in the second risk segment “b” by considering the point in which the risk level is the highest. In addition, among the plurality of risk areas, the fourth risk area farthest from the vehicle may have its risk area width that becomes wider in the second risk segment “b” by considering the point in which the risk level is the lowest.

According to an example, the processor 110 may determine a target speed for the target based on the distance the target is laterally separated from the vehicle and a risk area in which the target is located.

For example, the processor 110 may determine in which of the first risk segment “a” and the second risk segment “b” the target is located according to the distance the target is laterally separated from the vehicle.

The processor 110 may identify a risk area in which the target is located based on the risk area in which the target is present. The processor 110 may determine a target speed based on the risk area in which the target is located.

According to an example, the processor 110 may control the acceleration of the vehicle such that the rate of change in the acceleration of the vehicle is less than the rate of change in the deceleration of the vehicle based on controlling the speed of the vehicle such that the speed of the vehicle reaches the target speed. Here, the rate of change in the acceleration may include a value obtained by differentiating the acceleration and may be expressed as a jerk.

For example, if the vehicle is rapidly accelerated or rapidly decelerated, the vehicle may shake unstably. Accordingly, the processor 110 may limit the rate of change in the acceleration of the vehicle or the rate of change in the deceleration of the vehicle. Specifically, the processor 110 may control the speed of the vehicle based on a rate of change that is less than the rate of change in the acceleration (rate of change in the deceleration) required for the speed of the vehicle to reach the target speed.

According to an example, the processor 110 may control the acceleration of the vehicle such that the rate of change in the acceleration of the vehicle is less than the rate of change in the deceleration of the vehicle. That is, the processor 110 may limit the rate of change in the acceleration of the vehicle to a greater extent than the rate of change in the deceleration of the vehicle.

According to an example, the processor 110 may, based on the detection of a plurality of targets within a plurality of risk areas, determine at least one of a target speed for each of the plurality of targets, a start point for each of the plurality of targets, or an end point for each of the plurality of targets, or any combination thereof. That is, the target speed, the start point, and the end point may be determined for each of the plurality of targets.

In addition, the processor 110 may control the speed of the vehicle from the start point closest to the vehicle among the start points of the plurality of targets.

For example, if a first target and a second target that exist at different locations are detected, the processor 110 may identify a first target speed according to a risk area in which the first target is located, and identify a second target speed according to a risk area in which the second target is located. In addition, the processor 110 may determine a first start point and a first end point according to the first target, and determine a second start point and a second end point according to the second target. In this case, if the start point according to the first target is closer to the vehicle than the second start point according to the second target, the processor 110 may start controlling the speed of the vehicle to the first target speed from the first start point.

According to an example, the processor 110 may control the speed of the vehicle such that the speed of the vehicle reaches a slower target speed among a target speed according to the n-th target and a target speed according to the (n+1)-th target, based on the start point according to the (n+1)-th target that the vehicle reaches (n+1)-th being closer to the current location of the vehicle than the end point according to the n-th target that the vehicle reaches n-th. In this case, “n” may be defined as a natural number.

For example, if the second start point according to the second target that the vehicle reaches second is closer to the current location of the vehicle than the first end point according to the first target that the vehicle reaches first, the processor 110 may identify a slower target speed among the first target speed according to the first target and the second target speed according to the second target.

As a specific example, if the second target speed is slower than the first target speed, the processor 110 may control the speed of the vehicle to the second target speed after the vehicle has entered the second start point. That is, if there is competition in the first target speed according to the first target and the second target speed according to the second target, safety may be ensured by controlling the speed of the vehicle to the slower speed.

The above-described example is only one example, and the processor 110 may control the speed of the vehicle in the same manner as described above even if three or more multiple targets are detected.

According to an example, the processor 110 may control the speed of the vehicle to maintain the speed of the vehicle at the target speed until the vehicle reaches the point in which the target is located from the end point. That is, the processor 110 may control the speed of the vehicle such that the vehicle travels at the target speed if the vehicle reaches the end point, and allow the vehicle to travel while maintaining the target speed until the vehicle passes the target if the speed of the vehicle has reached the target speed. The vehicle may pass the target while traveling at the target speed, reducing the risk of collision between the target and the vehicle.

According to an example, the processor 110 may control the speed of the vehicle such that the speed of the vehicle reaches a speed before the speed of the vehicle has been controlled to the target speed after the vehicle has passed the point in which the target is located. For example, if the speed of the vehicle is controlled to the target speed of 30 km/h due to detection of a target while the vehicle is traveling at 80 km/h, the vehicle may be controlled to travel at 80 km/h again after passing the point in which the target is located.

According to an example, if a vehicle passes a point in which an n-th target is located while a plurality of targets is detected, the processor 110 may control the speed of the vehicle by considering a target speed according to the (n+1)-th target.

For example, if the vehicle reaches a start point according to the (n+1)-th target earlier than the point in which the n-th target is located, the processor 110 may control the speed of the vehicle to a target speed according to the (n+1)-th target after the vehicle has passed the point in which the n-th target is located.

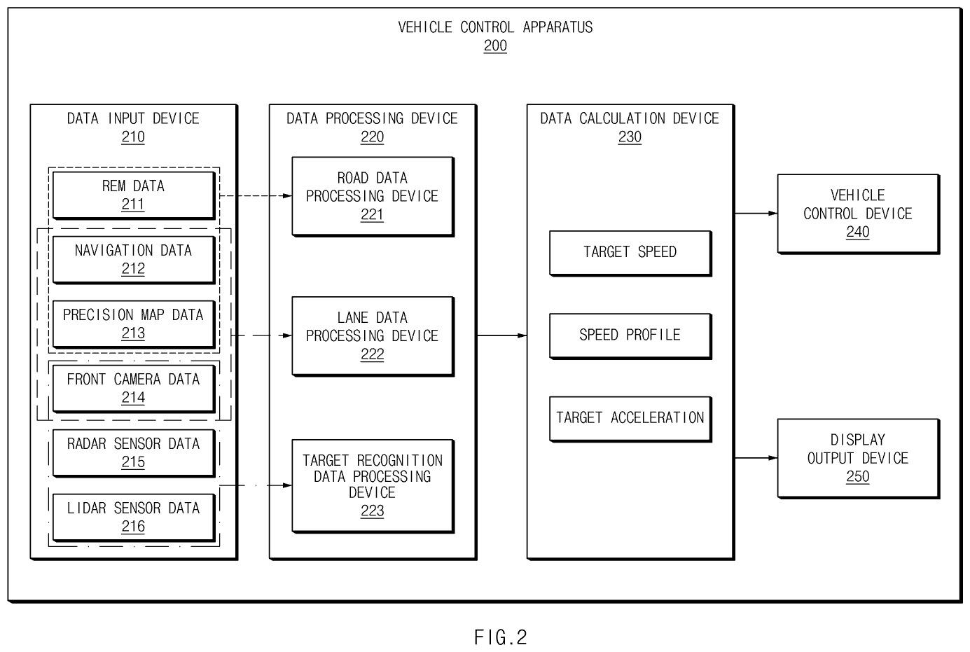

FIG. 2 shows an example of a process of processing data in a vehicle control apparatus according to an example of the present disclosure.

According to an example, a vehicle control apparatus 200 may include at least one processor that processes data based on a plurality of algorithms.

According to an example, the vehicle control apparatus 200 may include a data input device 210, a data processing device 220, a data calculation device 230, a vehicle control device 240, and a display output device 250. For example, the data input device 210, the data processing device 220, the data calculation device 230, the vehicle control device 240, and the display output device 250 may each correspond to a hardware component for processing data based on one or more instructions.

Specifically, the vehicle control apparatus 200 may include processors respectively corresponding to the data input device 210, the data processing device 220, the data calculation device 230, the vehicle control device 240, and the display output device 250. Alternatively, the vehicle control apparatus 200 may include a single processor that performs instructions for each of the data input device 210, the data processing device 220, the data calculation device 230, the vehicle control device 240, and the display output device 250.

According to an example, the data input device 210 may receive REM (Road Experience Management) data 211, navigation data 212, precision map data 213, front camera data 214, radar sensor data 215, and LiDAR sensor data 216.

The REM data 211 may include data collected via a Road Experience Management (REM) system. For example, the REM data 211 may include information related to road conditions, traffic volume, driver driving habits, surrounding environment, events occurring on roads, and/or the like.

The navigation data 212 may include information used to provide location-based services. For example, the navigation data 212 may include geographical information, traffic information, POI (Point Of Interest) information, route information, traffic information, and/or the like.

The precision map data 213 may include specific data on geographical information. For example, the precision map data 213 may include three-dimensional road environment information such as line information, guardrails, road curvature, road slope, traffic light locations, sign locations, and traffic markings.

The front camera data 214 may include data collected using a camera sensor that senses the front of a vehicle. The front camera data 214 may include, for example, information about vehicles, pedestrians, line information, road signs, road conditions, obstacles, and/or the like, existing in front of the vehicle.

The radar sensor data 215 may include data collected using a radar sensor. For example, the radar sensor data 215 may include distance information, speed information, and information about an object (speed of an object, location of an object, direction of an object, type of an object, or the like).

The LiDAR sensor data 216 may include data collected using a LiDAR sensor. For example, the LiDAR sensor data 216 may include distance information, height information, speed information, and information about an object (speed of an object, location of an object, direction of an object, type of an object, or the like).

According to an example, the data processing device 220 may include a road data processing device 221, a lane data processing device 222, and a target recognition data processing device 223.

According to an example, the road data processing device 221 may process data using the REM data 211, the navigation data 212, and the precision map data 213. For example, the road data processing device 221 may process information about the speed limit of a road, information about the boundaries of a road, and information about a region that a vehicle is currently traveling.

According to an example, the lane data processing device 222 may process data using the navigation data 212, the precision map data 213, and the front camera data 214. For example, the lane data processing device 222 may process information about a lane on which a vehicle is traveling, and information about surrounding lanes.

According to an example, the target recognition data processing device 223 may process data using the front camera data 214, the radar sensor data 215, and the LiDAR sensor data 216. For example, the target recognition data processing device 223 may process information about a target, including a vehicle, a powered two-wheeler (PTW), a moving obstacle, a stationary obstacle, a structured obstacle, an unstructured obstacle, a road boundary, and/or the like. Specifically, the information about the target may include, for example, a longitudinal location, a lateral location, a longitudinal speed, a lateral speed, and information about predicted movement of a target.

According to an example, the data calculation device 230 may determine a target speed, a speed profile, and a target acceleration based on the data processed by the data processing device 220.

According to an example, the vehicle control device 240 may control the vehicle based on the data determined by the data calculation device 230. For example, the vehicle control device 240 may control the speed of the vehicle to a target speed determined by the data calculation device 230.

According to an example, the display output device 250 may output the data determined by the data calculation device 230 to a display. For example, the display output device 250 may output a target speed or a target acceleration determined by the data calculation device 230 to the display. The user may identify the target speed of the vehicle via the display.

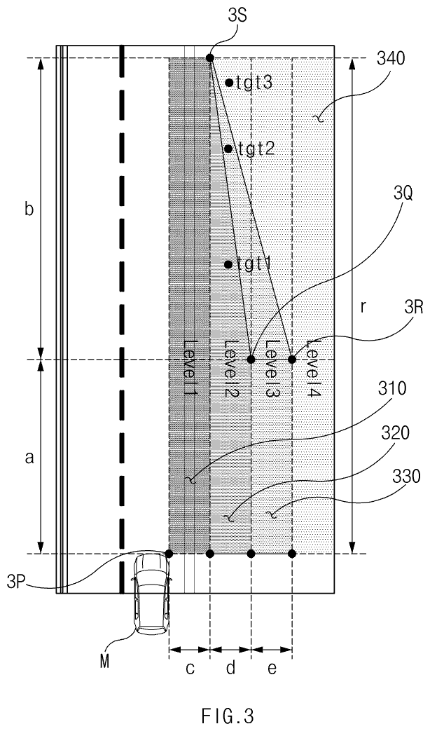

FIG. 3 shows an example of distinguishing a plurality of risk areas in a vehicle control apparatus according to an example of the present disclosure.

Referring to FIG. 3 according to an example, a longitudinal direction in FIG. 3 may be defined as a direction equal to the travel direction of a vehicle “M”, and a lateral direction in FIG. 3 may be defined as a direction perpendicular to the travel direction of the vehicle “M”.

According to an example, the vehicle control apparatus may divide a sidewalk close to a road on which the vehicle “M” is traveling into a plurality of risk areas. For example, the plurality of risk areas may include, in order of proximity to the vehicle “M”, a first risk area 310, a second risk area 320, a third risk area 330, and a fourth risk area 340.

According to an example, the vehicle control apparatus may separate a plurality of risk areas based on a point 3P at the right end of the front of the vehicle “M” if there is a sidewalk on the right side of the vehicle “M”.

According to an example, the plurality of risk areas may be specified as areas having a vertical length equal to a longitudinal distance “r” and a horizontal length equal to a lateral distance.

According to an example, the first risk area 310 may be specified based on a point (0,0) at the right end of the front of the vehicle “M”, a point (0,r) that is longitudinally separated from the vehicle “M” by the longitudinal distance “r” of the risk area, a first point (c,0) that is laterally separated from the vehicle “M” by the first distance “c”, and a point (c,r) that is longitudinally separated from the first point (c,0) by the longitudinal distance “r” of the risk area.

Therefore, the first risk area 310 may be identified as an area having a vertical length equal to the longitudinal distance “r” of the risk area and a horizontal length equal to the first distance “c”.

According to an example, the second risk area 320 may be specified based on the first point (c,0), a point (c,r) that is longitudinally separated from the first point (c,0) by the longitudinal distance “r” of the risk area, a second point (c+d,0) that is laterally separated from the first point (c,0) by a second distance “d”, and a point (c+d,r) that is longitudinally separated from the second point (c+d,0) by the longitudinal distance “r” of the risk area.

For example, the second risk area 320 may be identified as an area having a vertical length equal to the longitudinal distance “r” of the risk area and a horizontal length equal to the second distance “d”.

According to an example, the third risk area 330 may be specified based on the second point (c+d,0), a point (c+d,r) that is separated from the second point (c+d,0) by the longitudinal distance “r” of the risk area, a third point (c+d+e,0) that is laterally separated from the second point (c+d,0) by the third distance “e”, and a point (c+d+e,r) that is separated from the third point (c+d+e,0) by the longitudinal distance “r” of the risk area.

Therefore, the third risk area 330 may be identified as an area having a vertical length equal to the longitudinal distance “r” of the risk area and a horizontal length equal to the third distance “e”.

According to an example, the fourth risk area 340 may be specified as the remaining areas excluding the first risk area 310 to the third risk area 330.

According to an example, the second risk area 320 and the third risk area 330 may be divided into a first risk segment “a” that is within a specific longitudinal distance from the vehicle “M”, and a second risk segment “b” that is outside the specific longitudinal distance from the vehicle “M”.

According to an example, the width of the second risk area 320 in the second risk segment “b” and the width of the third risk area 330 in the second risk segment “b” may become narrower as they get further away from the vehicle “M”. Referring to FIG. 3, among points within the second risk area 320 and the third risk area 330, a point 3S that is the farthest in the longitudinal direction from the vehicle “M” and the closest in the lateral direction from the vehicle “M” may be identified as the point 3S in which the width of the risk area converges to 0.

For example, the width of the second risk area 320 in the second risk segment “b” may be gradually reduced from a point 3Q, in which the second risk segment “b” starts in the second risk area 320, to the point 3S.

For example, the width of the third risk area 330 in the second risk segment “b” may be gradually reduced from a point 3R, in which the second risk segment “b” starts in the third risk area 330, to the point 3S.

Accordingly, the second risk area 320 in the second risk segment “b” and the third risk area 330 in the second risk segment “b” may be formed in a triangular shape.

According to an example, the width of the first risk area 310 closest to the vehicle among the plurality of risk areas may not be narrowed even in the second risk segment “b”, considering that it has the highest risk level. In addition, among the plurality of risk areas, the fourth risk area 340 farthest from the vehicle may have its risk area width that becomes wider in the second risk segment “b” by considering the point in which the risk level is the lowest.

Referring to FIG. 3 according to an example, a first target tgt1 may be identified as being located in the second risk area 320, a second target tgt2 may be identified as being located in the third risk area 330, and a third target tgt3 may be identified as being located in the fourth risk area 340.

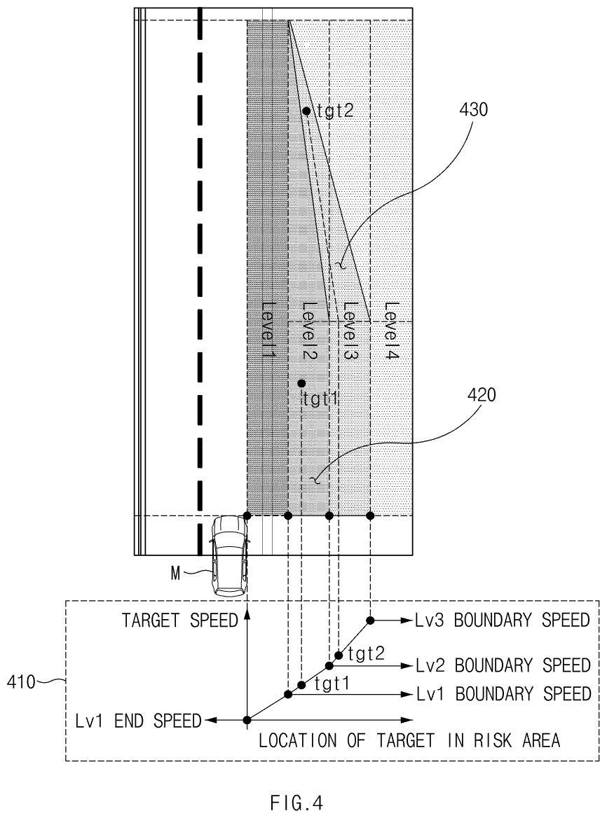

FIG. 4 shows an example in which a vehicle control apparatus according to an example of the present disclosure sets different target speeds for risk areas.

Referring to FIG. 4 according to an example, a plurality of risk areas, into which a sidewalk close to a road on which the vehicle “M” is traveling is divided, may be understood in the same manner as described in FIG. 3.

FIG. 4 according to an example includes a graph 410 for target speeds according to the location of a target within a risk area.

According to an example, the target speed may be set differently depending on the risk area where a target is located. For example, the target speed may be set differently according to a risk area. Specifically, the target speed may be lower as the target is located in an area in which there is a higher risk of collision with the vehicle “M”.

According to an example, the target speed in the first risk area (Level 1) may be set to a value between the Lv1 end speed and the Lv1 boundary speed. Here, the Lv1 end speed may be set to a speed that stops the vehicle “M”. For example, a target speed in the first risk area may be set to a range between a speed of 0% of the current speed of the vehicle “M” (Lv1 end speed) and a speed of 20% of the current speed of the vehicle “M” (Lv1 boundary speed).

According to an example, a target speed in the second risk area (Level 2) may be set to a value between the Lv1 boundary speed and the Lv2 boundary speed. For example, the target speed in the second risk area may be set to a range between a speed of 20% of the current speed of the vehicle “M” (Lv1 boundary speed) and a speed of 50% of the current speed of the vehicle “M” (Lv2 boundary speed).

According to an example, a target speed in the third risk area (Level 3) may be set to a value between the Lv2 boundary speed and the Lv3 boundary speed. For example, the target speed in the third risk area may be set to a range between a speed of 50% of the current speed of the vehicle “M” (Lv2 boundary speed) and a speed of 100% of the current speed of the vehicle “M” (Lv3 boundary speed).

According to an example, a target speed in the fourth risk area may be set to the same speed as the current speed of the vehicle “M”.

According to an example, even within the same risk area, the target speed may be set differently depending on a distance the target is laterally separated from the vehicle “M”. Here, the lateral direction may refer to a direction perpendicular to the traveling direction of the vehicle “M”.

For example, referring to the first target tgt1 of FIG. 3, the risk area in which the first target tgt1 is located may be identified as a second risk area (Level 2) 420. Among points of the second risk area (Level 2) 420 that exist at the same lateral distance as a point in which the first target tgt1 is located, a point closest to the vehicle “M” may be identified. Then, the ratio of a distance from the point closest to the identified vehicle “M” to the point in which the first target tgt1 is located with respect to the distance of the second risk area (Level 2) 420 that includes the point in which the first target tgt1 is located may be determined. Then, by applying the ratio to the range of the target speed of the second risk area (Level 2) 420, a target speed corresponding to the first target tgt1 may be determined.

As a specific example, if the distance of the second risk area (Level 2) 420 including the point in which the first target tgt1 is located is 10 m, and the distance from the point closest to the identified vehicle “M” to the point in which the first target tgt1 is located is 3 m, the distance ratio of the point in which the first target tgt1 is located in the second risk area (Level 2) 420 may be determined as 30%. In addition, if the current speed of the vehicle “M” is 100 km/h, the Lv1 boundary speed (a speed of 20% of the current speed of the vehicle) may be determined as 20 km/h, and the Lv2 boundary speed (a speed of 50% of the current speed of the vehicle) may be determined as 50 km/h. That is, the target speed in the second risk area (Level 2) 420 may be set to a speed between 20 km/h and 50 km/h, and the range in which the target speed in the second risk area (Level 2) 420 is able to change may be determined as 30 km/h (50 km/h-20 km/h). Because the distance ratio of the point, in which the first target tgt1 is located, in the second risk area (Level 2) 420 is 30% as described above, 30% of the range (30 km/h) in which the target speed is able to change may be determined as 9 km/h. Because the first target tgt1 is located at a distance of 30% from the point closest to the vehicle “M” (a point corresponding to the Lv1 boundary speed), a target speed according to the location of the first target tgt1 may be determined as 29 km/h.

According to an example, even if the risk area is divided into a first risk segment and a second risk segment, the target speed may be set differently according to a distance the target is laterally separated from the vehicle “M”.

For example, referring to the second target tgt2 of FIG. 3, the risk area in which the second target tgt2 is located may be identified as a third risk area (Level 3) 430. In addition, the third risk area (Level 3) 430 may be divided into a first risk segment and a second risk segment, and the width of the second risk segment may be narrower than that of the first risk segment. As a specific example, while the width of the third risk area (Level 3) 430 of the first risk segment may be 10 m, the width of the third risk area (Level 3) 430 of the second risk segment in which the second target tgt2 is located may be identified as 5 m.

For example, as the second target tgt2 is located in the second risk segment of the third risk area (Level 3) 430, the distance of the third risk area (Level 3) 430 including the point in which the second target tgt2 is located may be identified as 5 m. Further, if the distance from the point closest to the identified vehicle “M” to the point in which the second target tgt2 is located is 1 m, the distance ratio of the point in which the second target tgt2 is located in the third risk area (Level 3) 430 may be determined as 20%. In this case, if the current speed of the vehicle “M” is 100 km/h, the Lv2 boundary speed (a speed of 50% of the current speed of the vehicle) may be determined as 50 km/h, and the Lv3 boundary speed (a speed of 100% of the current speed of the vehicle) may be determined as 100 km/h.

That is, the target speed in the third risk area (Level 3) 430 may be set to a speed between 50 km/h and 100 km/h, and the range in which the target speed in the third risk area (Level 3) 430 is able to change may be determined as 50 km/h (100 km/h-50 km/h). Because the distance ratio of the point, in which the second target tgt2, in the third risk area (Level 3) 430 is located is 20% as described above, 20% of the range (50 km/h) in which the target speed is able to change may be determined as 10 km/h. Because the second target tgt2 is located at a distance of 20% from the point closest to the vehicle “M” (a point corresponding to the Lv2 boundary speed), a target speed according to the location of the second target tgt2 may be determined as 60 km/h.

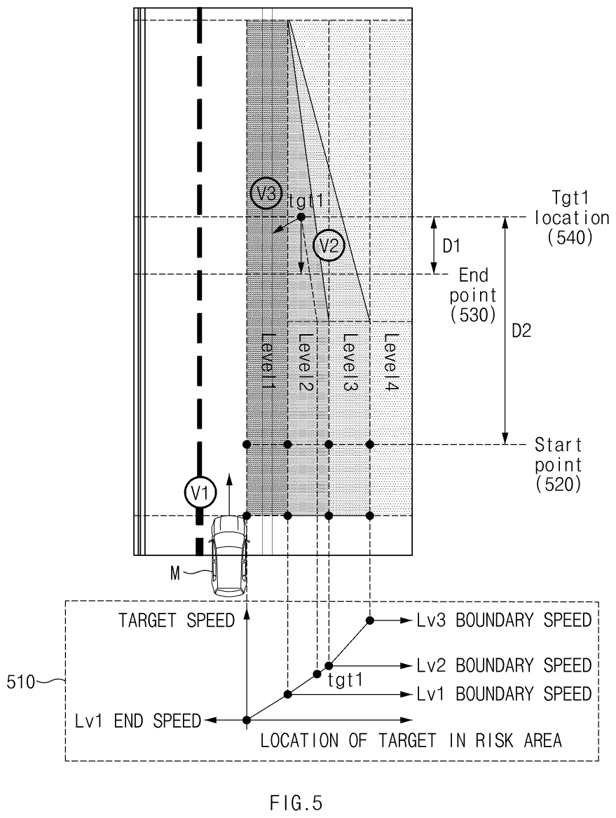

FIG. 5 shows an example of determining a start point for a segment in which a speed of a vehicle is controlled to a target speed, and an end point for a segment in which the speed of the vehicle is controlled to the target speed in a vehicle control apparatus according to an example of the present disclosure.

Referring to FIG. 5 according to an example, a plurality of risk areas, into which a sidewalk close to a road on which the vehicle “M” is traveling is divided, may be understood in the same manner as described in FIG. 3.

FIG. 5 according to an example includes a graph 510 for target speeds according to the location of a target within a risk area.

According to an example, the vehicle control apparatus may identify information about a speed V1 of a vehicle, and the first target tgt1. For example, the vehicle control apparatus may identify a longitudinal speed V2 of the first target tgt1, a lateral speed V3 of the first target tgt1, a location 540 of the first target tgt1, or a risk area in which the first target tgt1 is located. Referring to FIG. 5 according to an example, the vehicle control apparatus may identify the first target tgt1 located in a second risk area (Level 2).

According to an example, the vehicle control apparatus may identify a segment for controlling the speed of the vehicle to a target speed according to the first target tgt1. Specifically, the vehicle control apparatus may determine a start point 520 and an end point 530 of the segment for controlling the speed V1 of the vehicle to the target speed.

According to an example, the vehicle control apparatus may determine the start point 520 based on the second Time-gap parameter and the speed V1 of the vehicle “M”. Specifically, the processor 110 may determine a distance D1 related to the start point 520 based on the product of the second Time-gap parameter and the speed V1 of the vehicle “M”. Further, the vehicle control apparatus may determine, as the start point 520, a point that is separated from the first target tgt1 by the distance D1 related to the start point 520 in a direction toward the vehicle “M”.

According to an example, the vehicle control apparatus may determine the end point 530 of the segment for controlling the speed V1 of the vehicle “M” to the target speed based on the longitudinal speed V2 of the first target tgt1 and the second Time-gap parameter according to the longitudinal speed V2 of the first target tgt1. Specifically, the vehicle control apparatus may determine a distance D2 related to the end point 530 based on the product of the second Time-gap parameter according to the longitudinal speed V2 of the first target tgt1 and the longitudinal speed V2 of the first target tgt1. The vehicle control apparatus may determine, as the end point 530, a point that is separated from the first target tgt1 by the distance D2 related to the end point 530 in the direction toward the vehicle “M”.

According to an example, the vehicle control apparatus may calibrate the second Time-gap parameter by applying at least one of a first weight according to the lateral speed V3 of the first target tgt1, or a second weight according to the risk area in which the first target tgt1 is located, or any combination thereof, to the second Time-gap parameter, and determine the start point 520 based on the calibrated second Time-gap parameter.

According to an example, the vehicle control apparatus may apply the first weight according to the lateral speed V3 of the first target tgt1 to the second Time-gap parameter. The first weight according to the lateral speed V3 of the first target tgt1 may include a gain value set according to the lateral speed V3 of the first target tgt1.

For example, the first weight may be set to a larger value as the first target tgt1 moves laterally closer to the vehicle. In addition, the first weight may be set to a larger value as the lateral speed V3 of the first target tgt1 increases.

According to an example, the processor 110 may determine whether the first target tgt1 is moving laterally away from the vehicle “M” or moving laterally closer to the vehicle via the sign of the lateral speed V3 of the first target tgt1.

For example, the first weight may be set to a larger value as the first target tgt1 moves laterally closer to the vehicle. In addition, the first weight may be set to a larger value as the lateral speed V3 of the first target tgt1 increases.

According to an example, the vehicle control apparatus may apply a second weight according to a risk area, in which the first target tgt1 is located, to the second Time-gap parameter. In this case, the second weight according to the identified risk area may be set to a larger value as the risk area has a higher risk of collision between the first target tgt1 and the vehicle “M”. For example, the second weight according to the first risk area (Level 1) may be higher than the weight according to the second risk area (Level 2).

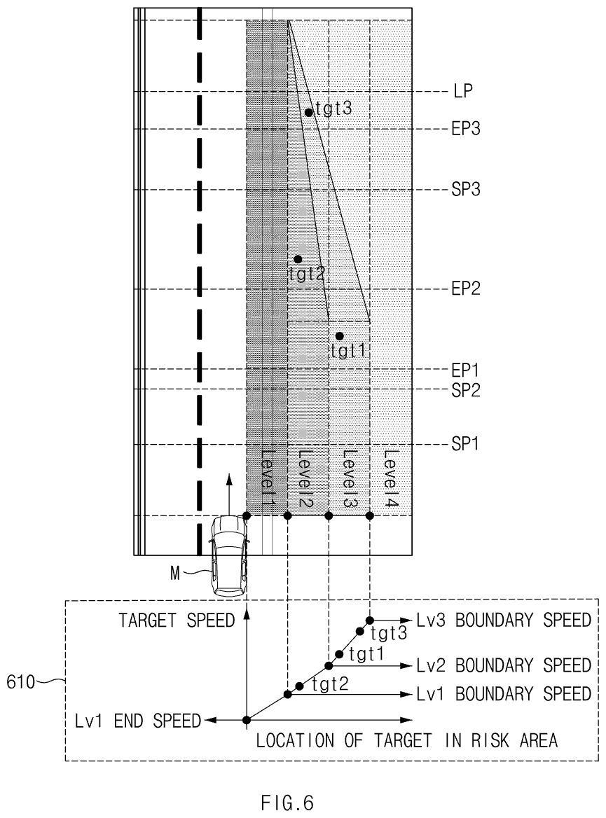

FIG. 6 shows an example of a plurality of segments in which the speed of a vehicle is controlled differently based on detection of a plurality of targets in a vehicle control apparatus according to an example of the present disclosure.

Referring to FIG. 6 according to an example, a plurality of risk areas, into which a sidewalk close to a road on which the vehicle “M” is traveling is divided, may be understood in the same manner as described in FIG. 3.

Referring to FIG. 6 according to an example, a method for determining a start point and an end point determined for each of a plurality of targets may be understood in the same manner as described in FIG. 5.

FIG. 6 according to an example includes a graph 610 for target speeds according to the location of a target within a risk area.

According to an example, if a plurality of targets is detected, the vehicle control apparatus may determine a target speed of each of the plurality of targets, a start point of each of the plurality of targets, and an end point of each of the plurality of targets.

Referring to FIG. 6 according to an example, the vehicle control apparatus may identify the first target tgt1 located in the third risk area, the second target tgt2 located in the second risk area, and the third target tgt3 located in the second risk area.

According to an example, the vehicle control apparatus may respectively identify a first target speed according to the first target tgt1, a second target speed according to the second target tgt2, and a third target speed according to the third target tgt3.

According to an example, the vehicle control apparatus may determine a first start point SP1 according to the first target tgt1, a first end point EP1 according to the first target tgt1, a second start point SP2 according to the second target tgt2, a second end point EP2 according to the second target tgt2, a third start point SP3 according to the third target tgt3, and a third end point EP3 according to the third target tgt3, individually.

Referring to FIG. 6 according to an example, the vehicle control apparatus may control the speed of the vehicle “M” according to in the order of proximity to the vehicle “M”. For example, the vehicle control apparatus may start controlling the speed of the vehicle “M” to the first target speed from the first start point SP1.

If the vehicle “M” reaches the second start point SP2, the vehicle control apparatus may control the speed of the vehicle “M” to the second target speed from the second start point SP2. If the first target speed is less than the second target speed, the vehicle control apparatus may continue to control the speed of the vehicle “M” to the first target speed even after the second start point SP2.

According to an example, if the second start point SP2 is reached after the point in which the first target tgt1 is located, the vehicle control apparatus may control the speed of the vehicle “M” to the first target speed until the vehicle “M” reaches the point in which the first target tgt1 is located after the vehicle “M” has reached the first end point EP1.

However, as shown in FIG. 6, if the second start point SP2 is reached earlier than the point in which the first target tgt1 is located, the vehicle control apparatus may continue to control the speed of the vehicle “M” to the second target speed even after the vehicle “M” has reached the first end point EP1.

Referring to FIG. 6 according to an example, the vehicle control apparatus may maintain the speed of the vehicle “M” at the second target speed until the vehicle “M” reaches the point in which the second target tgt2 is located after the vehicle “M” has reached the second end point EP2. Subsequently, if the vehicle “M” passes the point in which the second target tgt2 is located, the vehicle control apparatus may control the speed of the vehicle “M” back to the speed before being controlled to the target speed.

Referring to FIG. 6 according to an example, the vehicle control apparatus may control the speed of the vehicle “M” to a third target speed according to the third target tgt3 from the third start point SP3. After the vehicle “M” has reached the third end point EP3, the vehicle control apparatus may maintain the speed of the vehicle “M” at the third target speed until the vehicle “M” reaches the point in which the third target tgt3 is located. Thereafter, if the vehicle “M” passes the point in which the third target tgt3 is located, the vehicle control apparatus may control the speed of the vehicle “M” back to the speed before being controlled to the target speed.

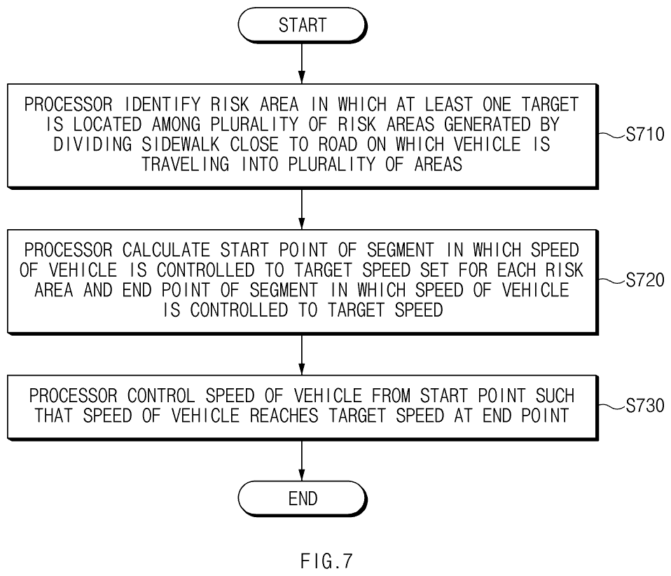

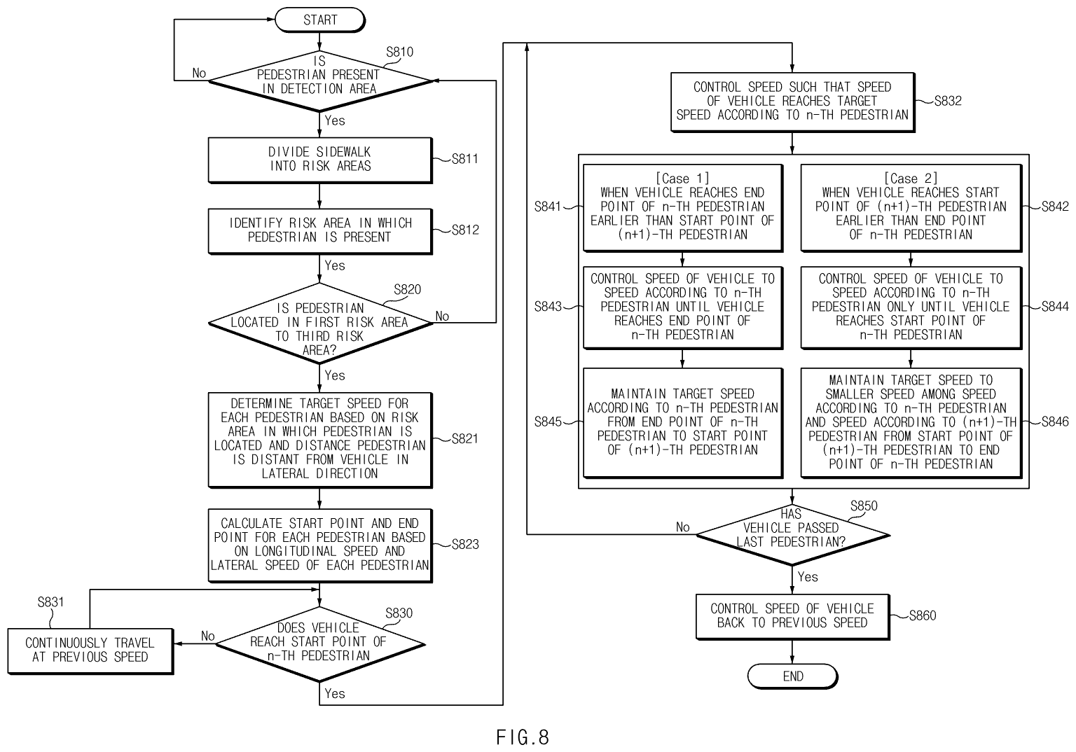

Hereinafter, a vehicle control apparatus or a vehicle control method according to an example of the present disclosure will be specifically described with reference to FIGS. 7 and 8. For convenience, FIG. 7 and FIG. 8 are described by way of an example in which the steps are performed by a processor (e.g., control circuitry). One, some, or all steps of FIG. 7 and FIG. 8, or portions thereof, may be performed by one or more other circuits. One or some, steps of FIG. 7 and FIG. 8 may be omitted, performed in other orders, and/or otherwise modified, and/or one or more additional steps may be added.

The vehicle control apparatus 100 of FIG. 1 may perform the process of FIG. 7 or FIG. 8. In addition, each operation of FIG. 7 or FIG. 8 may be understood as being controlled by, for example, the processor 110 of the vehicle control apparatus 100.

FIG. 7 shows an example of a vehicle control apparatus or a vehicle control method according to an example of the present disclosure.

According to an example, the processor of a vehicle control apparatus may identify a risk area in which at least one target is located, among a plurality of risk areas generated by dividing a sidewalk adjacent to a road, on which a vehicle is traveling, into a plurality of areas (S710).

As a specific example, the processor of the vehicle control apparatus may divide a sidewalk close to a road on which a vehicle is traveling, into a plurality of risk areas based on at least one of the speed of the vehicle, a distance detected by a sensor, a predetermined longitudinal distance from the vehicle, a predetermined lateral distance from the vehicle, or a first Time-gap parameter predetermined corresponding to the speed of the vehicle, or any combination thereof.

According to an example, the processor of the vehicle control apparatus may determine the start point of a segment in which the speed of the vehicle is controlled to a target speed set for each risk area, and the end point of the segment in which the speed of the vehicle is controlled to the target speed (S720).

As a specific example, the processor of the vehicle control apparatus may determine a start point of a segment in which the speed of the vehicle is controlled to a target speed set for each risk area, and an end point of a segment in which the speed of the vehicle is controlled to a target speed, based on at least one of the speed of the vehicle, the longitudinal speed of a target, or the second Time-gap parameter predetermined corresponding to the longitudinal speed of the target, or any combination thereof.

According to an example, the processor of the vehicle control apparatus may control the speed of the vehicle from the start point such that the speed of the vehicle reaches the target speed at the end point (S730).

FIG. 8 shows an example of a process of controlling the speed of a vehicle based on the detection of a plurality of targets by a vehicle control apparatus or a vehicle control method according to an example of the present disclosure.

According to an example, a vehicle control apparatus may determine whether a pedestrian exists within an area that is detectable by a sensor (S810).

If a pedestrian exists within an area that is detectable by a sensor, the vehicle control apparatus may divide a sidewalk close to a road on which the vehicle is traveling into a plurality of risk areas (S811). For example, the vehicle control apparatus may determine that a risk area closer to a vehicle has a higher risk of collision between a target and the vehicle. Specifically, the vehicle control apparatus may determine risk areas with higher risk in the order of the first risk area, the second risk area, the third risk area, and the fourth risk area.

In addition, the vehicle control apparatus may identify the risk area in which the pedestrian is located among the plurality of risk areas (S812). For example, if the pedestrian is located in the risk area closest to the vehicle, the vehicle control apparatus may identify the area in which the pedestrian is located as a first risk area.

According to an example, the vehicle control apparatus may determine whether a pedestrian is located in the first risk area to the third risk area (S820).

If a pedestrian is located in the first risk area to the third risk area, the vehicle control apparatus may determine a target speed for each pedestrian based on the risk area in which a pedestrian is located and the distance in the lateral direction the pedestrian is separated from the vehicle (S821).

The vehicle control apparatus may determine the start point and the end point of the pedestrian based on the longitudinal speed and the lateral speed of the pedestrian (S823).

According to an example, if a plurality of pedestrians is detected, the vehicle control apparatus may determine the start point and the end point of each of the plurality of pedestrians.

According to an example, the vehicle control apparatus may determine whether the vehicle has reached the start point of the n-th pedestrian (S830). If the vehicle has not yet reached the start point of the n-th pedestrian, the vehicle control apparatus may control the vehicle to continuously travel at an existing speed.

According to an example, if the vehicle has reached the start point according to the n-th pedestrian, the vehicle control apparatus may control the speed of the vehicle such that the speed of the vehicle reaches the target speed according to the n-th pedestrian (S832).

According to an example, the vehicle control apparatus may determine which point of the start point of the (n+1)-th pedestrian and the end point of the n-th pedestrian the vehicle is able to reach first.

According to an example, if the vehicle reaches the end point of the n-th pedestrian earlier than the start point of the (n+1)-th pedestrian (S841), the vehicle control apparatus may control the speed of the vehicle to a target speed according to the n-th pedestrian until the vehicle reaches the end point of the n-th pedestrian (S843). Further, the vehicle control apparatus may control the speed of the vehicle such that the target speed according to the n-th pedestrian is maintained from the end point of the n-th pedestrian to the start point of the (n+1)-th pedestrian (S845).

According to an example, if the vehicle reaches the start point of the (n+1)-th pedestrian earlier than the end point of the n-th pedestrian (S842), the vehicle control apparatus may control the speed of the vehicle to the target speed according to the n-th pedestrian only until the vehicle reaches the start point of the (n+1)-th pedestrian (S844). In addition, the vehicle control apparatus may control the speed of the vehicle to the smaller speed among the speed according to the n-th pedestrian and the speed according to the (n+1)-th pedestrian from the start point of the (n+1)-th pedestrian to the end point of the n-th pedestrian (S846).

According to an example, the vehicle control apparatus may determine whether the vehicle has passed the point in which the last pedestrian is located (S850). If the vehicle has passed the point in which the last pedestrian is located, the vehicle control apparatus may control the speed of the vehicle back to a previous speed (S860). For example, the vehicle control apparatus may control the speed of the vehicle back to the speed before being controlled to the target speed.

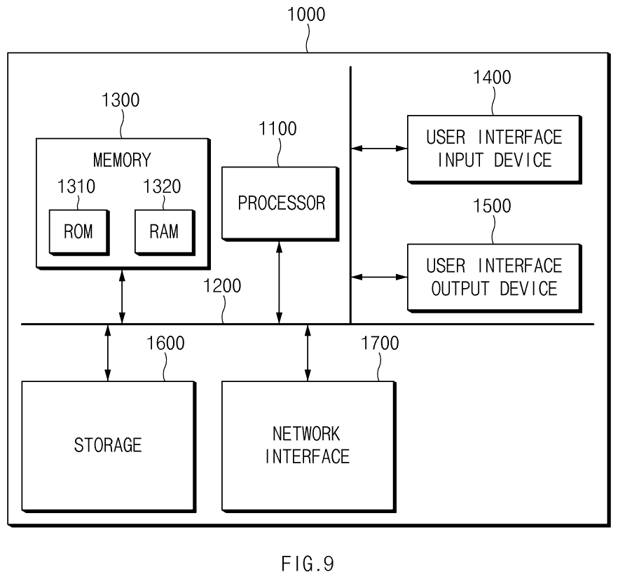

FIG. 9 shows an example of a computing system related to a vehicle control apparatus or a vehicle control method according to an example of the present disclosure.

Referring to FIG. 9, a computing system 1000 may include at least one processor 1100, a memory 1300, a user interface input device 1400, a user interface output device 1500, storage 1600, and a network interface 1700, which are connected with each other via a bus 1200.

The processor 1100 may be a central processing unit (CPU) or a semiconductor device that processes instructions stored in the memory 1300 and/or the storage 1600. The memory 1300 and the storage 1600 may include various types of volatile or non-volatile storage media. For example, the memory 1300 may include a ROM (Read Only Memory) 1310 and a RAM (Random Access Memory) 1320.

Thus, the operations of the method or the algorithm described in connection with the examples disclosed herein may be embodied directly in hardware or a software module executed by the processor 1100, or in a combination thereof. The software module may reside on a storage medium (that is, the memory 1300 and/or the storage 1600) such as a RAM, a flash memory, a ROM, an EPROM, an EEPROM, a register, a hard disk, a removable disk, and a CD-ROM.

The exemplary storage medium may be coupled to the processor 1100, and the processor 1100 may read information out of the storage medium and may record information in the storage medium. Alternatively, the storage medium may be integrated with the processor 1100. The processor and the storage medium may reside in an application specific integrated circuit (ASIC). The ASIC may reside within a user terminal. In another case, the processor and the storage medium may reside in the user terminal as separate components.

The present disclosure has been made to solve the above-mentioned problems occurring in the prior art while advantages achieved by the prior art are maintained intact.

An example of the present disclosure provides a vehicle control apparatus and a vehicle control method capable of minimizing the risk of collision between a vehicle and a pedestrian by reducing the speed of a vehicle in advance according to the presence or absence of a pedestrian on a sidewalk close to a road on which the vehicle is traveling and the behavior of the pedestrian.

An example of the present disclosure provides a vehicle control apparatus and a vehicle control method capable of controlling the speed of the vehicle differently depending on distances of multiple pedestrians from the vehicle in the longitudinal direction, if the multiple pedestrians are at different distances from the vehicle in the longitudinal direction even though the multiple pedestrians are located at the same distance from the vehicle in the lateral direction.

An example of the present disclosure provides a vehicle control apparatus and a vehicle control method capable of organically determining and changing the target speed of the vehicle, the start point for starting control of the speed of the vehicle, and the end point for ending control of the speed of the vehicle, based on the location of the pedestrian, the longitudinal speed of the pedestrian, and the lateral speed of the pedestrian.

The technical problems to be solved by the present disclosure are not limited to the aforementioned problems, and any other technical problems not mentioned herein will be clearly understood from the following description by those skilled in the art to which the present disclosure pertains.

According to an example of the present disclosure, a vehicle control apparatus includes a memory configured that stores a parameter used to determine a distance varying according to a speed, and program instructions; and a processor that executes the program instructions, and the processor may identify a risk area in which at least one target is located, among a plurality of risk areas generated by dividing a sidewalk close to a road, on which a vehicle is traveling, into a plurality of areas, determine a start point of a segment in which a speed of the vehicle is controlled to a target speed set for each of the risk areas and an end point of the segment in which the speed of the vehicle is controlled to the target speed, and control the speed of the vehicle from the start point such that the speed of the vehicle reaches the target speed at the end point.

According to an example, the processor may divide the sidewalk into the plurality of risk areas based on at least one of the speed of the vehicle, a distance detected by a sensor, a predetermined longitudinal distance from the vehicle, a predetermined lateral distance from the vehicle, or a first parameter predetermined corresponding to the speed of the vehicle, or any combination thereof.

According to an example, the processor may determine the start point of the segment in which the speed of the vehicle is controlled to the target speed set for each of the risk areas and the end point of the segment in which the speed of the vehicle is controlled to the target speed, based on at least one of the speed of the vehicle, a longitudinal speed of the target, or a second parameter predetermined corresponding to the longitudinal speed of the target, or any combination thereof.

According to an example, the processor may identify, as a longitudinal distance of the risk area, a greater distance of the predetermined longitudinal distance from the vehicle and the distance detected by the sensor, identify a first risk area included in the plurality of risk areas, based on a point separated from the vehicle by the longitudinal distance of the risk area and a first point laterally separated from the vehicle by a first distance, identify a second risk area included in the plurality of risk areas, based on the point separated from the vehicle by the longitudinal distance of the risk area and a second point separated from the first point by a second distance, identify a third risk area included in the plurality of risk areas, based on the point separated from the vehicle by the longitudinal distance of the risk area and a third point separated from the second point by a third distance, or identify a remaining area of the plurality of risk areas, excluding the first to third risk areas, as a fourth risk area.

According to an example, the processor may identify the plurality of risk areas that are wider as the speed of the vehicle increases.

According to an example, the processor may divide at least one risk area of the plurality of risk areas into a first risk segment that is within a specific longitudinal distance from the vehicle, and a second risk area that is outside the specific longitudinal distance from the vehicle, and a width of the at least one risk area in the second risk area may be narrower as the at least one risk area is further away from the vehicle.

According to an example, the processor may determine the target speed for the target based on a distance the target is laterally separated from the vehicle and a risk area in which the target is located.

According to an example, the processor may determine the start point based on the second parameter and the speed of the vehicle.

According to an example, the processor may calibrate the second parameter by applying at least one of a first weight according to a lateral speed of the target, or a second weight according to the risk area, or any combination thereof, to the second parameter, and determine the start point based on the second parameter calibrated.

According to an example, the processor may control an acceleration of the vehicle such that a rate of change in the acceleration of the vehicle is less than a rate of change in a deceleration of the vehicle based on controlling the speed of the vehicle such that the speed of the vehicle reaches the target speed.

According to an example, the processor may, based on the detection of a plurality of targets within the plurality of risk areas, determine at least one of a target speed for each of the plurality of targets, a start point for each of the plurality of targets, or an end point for each of the plurality of targets, or any combination thereof, and control the speed of the vehicle from a start point closest to the vehicle among start points according to the plurality of targets.

According to an example, the processor may control the speed of the vehicle such that the speed of the vehicle reaches a slower target speed among a target speed according to an n-th target and a target speed according to an (n+1)-th target, based on a start point according to the (n+1)-th target that the vehicle reaches (n+1)-th being closer to a current location of the vehicle than an end point according to the n-th target that the vehicle reaches n-th, and the “n” may a natural number.

According to an example, the processor may control the speed of the vehicle such that the speed of the vehicle is maintained at the target speed until the vehicle reaches a point in which the target is located from the end point, and control the speed of the vehicle such that the speed of the vehicle reaches a speed before the speed of the vehicle has been controlled to the target speed after the vehicle has passed the point in which the target is located.

According to an example, the parameter includes a Time-Gap parameter in units of time.

According to an example of the present disclosure, a vehicle control method includes identifying or determining, by a processor, a risk area in which at least one target is located, among a plurality of risk areas generated by dividing a sidewalk close to a road, on which a vehicle is traveling, into a plurality of areas, determining, by the processor, a start point of a segment in which a speed of the vehicle is controlled to a target speed set for each of the risk areas and an end point of the segment in which the speed of the vehicle is controlled to the target speed, and controlling, by the processor, the speed of the vehicle from the start point such that the speed of the vehicle reaches the target speed at the end point.

According to an example, the identifying, by the processor, of the risk area in which at least one target is located, among the plurality of risk areas generated by dividing the sidewalk close to the road, on which the vehicle is traveling, into the plurality of areas may include dividing, by the processor, the sidewalk into the plurality of risk areas based on at least one of the speed of the vehicle, a distance detected by a sensor, a predetermined longitudinal distance from the vehicle, a predetermined lateral distance from the vehicle, or a first parameter predetermined corresponding to the speed of the vehicle, or any combination thereof.

According to an example, the determining, by the processor, of the start point of the segment in which the speed of the vehicle is controlled to the target speed set for each of the risk areas and the end point of the segment in which the speed of the vehicle is controlled to the target speed may include determining, by the processor, the start point of the segment in which the speed of the vehicle is controlled to the target speed set for each of the risk areas and the end point of the segment in which the speed of the vehicle is controlled to the target speed, based on at least one of the speed of the vehicle, a longitudinal speed of the target, or a second parameter predetermined corresponding to the longitudinal speed of the target, or any combination thereof.

According to an example, the dividing, by the processor, of the sidewalk into the plurality of risk areas based on at least one of the speed of the vehicle, the distance detected by the sensor, the predetermined longitudinal distance from the vehicle, the predetermined lateral distance from the vehicle, or the first parameter predetermined corresponding to the speed of the vehicle, or any combination thereof may include identifying or determining, by the processor, as a longitudinal distance of the risk area, a greater distance of the predetermined longitudinal distance from the vehicle and the distance detected by the sensor.

According to an example, the dividing, by the processor, of the sidewalk into the plurality of risk areas based on at least one of the speed of the vehicle, the distance detected by the sensor, the predetermined longitudinal distance from the vehicle, the predetermined lateral distance from the vehicle, or the first parameter predetermined corresponding to the speed of the vehicle, or any combination thereof may include dividing, by the processor, at least one risk area of the plurality of risk areas into a first risk segment that is within a specific longitudinal distance from the vehicle, and a second risk area that is outside the specific longitudinal distance from the vehicle, and a width of the at least one risk area in the second risk area may be narrower as the at least one risk area is further away from the vehicle.

According to an example, the determining, by the processor, of the start point of the segment in which the speed of the vehicle is controlled to the target speed set for each of the risk areas and the end point of the segment in which the speed of the vehicle is controlled to the target speed may include determining, by the controller, the start point based on the second parameter and the speed of the vehicle.

According to an example, the determining, by the processor, of the start point of the segment in which the speed of the vehicle is controlled to the target speed set for each of the risk areas and the end point of the segment in which the speed of the vehicle is controlled to the target speed may include determining, by the processor, at least one of a target speed for each of the plurality of targets, a start point for each of the plurality of targets, or an end point for each of the plurality of targets, or any combination thereof based on the detection of a plurality of targets within the plurality of risk areas, and the controlling, by the processor, of the speed of the vehicle from the start point such that the speed of the vehicle reaches the target speed at the end point may include controlling, by the processor, the speed of the vehicle from a start point closest to the vehicle among start points according to the plurality of targets.

The above description is merely illustrative of the technical idea of the present disclosure, and various modifications and variations may be made without departing from the essential characteristics of the present disclosure by those skilled in the art to which the present disclosure pertains.

Accordingly, the example disclosed in the present disclosure is not intended to limit the technical idea of the present disclosure but to describe the present disclosure, and the scope of the technical idea of the present disclosure is not limited by the example. The scope of protection of the present disclosure should be interpreted by the following claims, and all technical ideas within the scope equivalent thereto should be construed as being included in the scope of the present disclosure.

The present technology may minimize the risk of collision between a vehicle and a pedestrian by reducing the speed of a vehicle in advance according to the presence or absence of a pedestrian on a sidewalk close to a road on which the vehicle is traveling and the behavior of the pedestrian.

Further, the present technology may control the speed of the vehicle differently depending on distances of multiple pedestrians from the vehicle in the longitudinal direction, if the multiple pedestrians are at different distances from the vehicle in the longitudinal direction even though the multiple pedestrians are located at the same distance from the vehicle in the lateral direction.

Further, the present technology may organically determine and change the target speed of the vehicle, the start point for starting control of the speed of the vehicle, and the end point for ending control of the speed of the vehicle, based on the location of the pedestrian, the longitudinal speed of the pedestrian, and the lateral speed of the pedestrian.

In addition, various effects may be provided that are directly or indirectly understood via the disclosure.

Hereinabove, although the present disclosure has been described with reference to examples and the accompanying drawings, the present disclosure is not limited thereto, but may be variously modified and altered by those skilled in the art to which the present disclosure pertains without departing from the spirit and scope of the present disclosure claimed in the following claims.

What is claimed is:

1. An apparatus for controlling a vehicle, the apparatus comprising:
a memory configured to store a parameter associated with speed-based distance adjustment; and
a processor, by executing program instructions, configured to:
determine, based on the parameter and a speed of the vehicle, at least one distance between the vehicle and at least one target, wherein the at least one distance is a varying distance based on the speed of the vehicle,
identify, based on the at least one distance, a risk area among a plurality of risk areas, wherein at the least one target is located in the risk area, wherein the plurality of risk areas are generated by dividing a sidewalk into a plurality of areas, and wherein the sidewalk is within a threshold distance from a road on which the vehicle is traveling;
determine a start point of a segment associated with the risk area and determine an end point of the segment associated with the risk area, wherein a target speed is set for the risk area; and
control the speed of the vehicle from the start point such that the speed of the vehicle reaches the target speed at the end point.

2. The apparatus of claim 1, wherein the processor is configured to divide the sidewalk into the plurality of areas based on at least one of:
the speed of the vehicle,
a distance detected by a sensor,
a predetermined longitudinal distance from the vehicle,
a predetermined lateral distance from the vehicle, or
a predetermined parameter corresponding to the speed of the vehicle.

3. The apparatus of claim 1, wherein the processor is configured to determine the start point and the end point based on at least one of: the speed of the vehicle a longitudinal speed of the at least one target, or a predetermined parameter corresponding to the longitudinal speed of the at least one target.

4. The apparatus of claim 2, wherein the processor is configured to perform at least one of:
identifying a longitudinal distance of the risk area, wherein the longitudinal distance is a greater of the longitudinal distance from the vehicle and the distance detected by the sensor;
identifying a first risk area among the plurality of risk areas, based on a point separated from the vehicle by the longitudinal distance of the risk area and a first point laterally separated from the vehicle by a first distance;
identifying a second risk area among the plurality of risk areas, based on the point and a second point separated from the first point by a second distance;
identifying a third risk area among the plurality of risk areas, based on the point and a third point separated from the second point by a third distance; or
identifying a fourth risk area among the plurality of risk areas, wherein the fourth risk area is a remaining area after excluding the first to third risk areas from the plurality of risk areas.

5. The apparatus of claim 1, wherein the processor is configured to determine the plurality of risk areas, wherein boundaries of the plurality of risk areas expand as the speed of the vehicle increases.

6. The apparatus of claim 1, wherein the processor is configured to divide at least one risk area of the plurality of risk areas into:
a first risk segment that is within a specific longitudinal distance from the vehicle, and
a second risk segment that is outside the specific longitudinal distance from the vehicle, and
wherein a width of the at least one risk area in the second risk segment becomes narrower as the at least one risk area is farther away from the vehicle.

7. The apparatus of claim 1, wherein the processor is configured to determine the target speed for the at least one target based on a distance separating the at least one target laterally from the vehicle and based on the risk area in which the at least one target is located.

8. The apparatus of claim 1, wherein the processor is configured to determine the start point based on the predetermined parameter and the speed of the vehicle.

9. The apparatus of claim 8, wherein the processor is configured to:
calibrate the predetermined parameter based on at least one of:
a first weight according to a lateral speed of the at least one target, or
a second weight according to the risk area; and
determine the start point based on the calibrated parameter.

10. The apparatus of claim 1, wherein the processor is configured to control an acceleration of the vehicle such that a rate of change in the acceleration of the vehicle is less than a rate of change in a deceleration of the vehicle, thereby enabling control of the speed of the vehicle from the start point so that the speed of the vehicle reaches the target speed at the end point.

11. The apparatus of claim 1, wherein the processor is configured to, based on detecting a plurality of targets within the plurality of risk areas, determine at least one of:
a plurality of target speeds for the plurality of targets, wherein each of the plurality of targets corresponds to a respective one of the plurality of target speeds,
a plurality of start points for the plurality of targets, wherein each of the plurality of targets corresponds to a respective one of the plurality of start points, or
a plurality of end points for the plurality of targets, wherein each of the plurality of targets corresponds to a respective one of the plurality of end points; and
control the speed of the vehicle from a start point among the plurality of start points, wherein the start point is a point closest to the vehicle.

12. The apparatus of claim 11, wherein the processor is configured to control the speed of the vehicle such that the speed of the vehicle reaches a slower target speed between an n-th target speed associated with an n-th target and an (n+1)-th target speed associated with an (n+1)-th target, based on a start point associated with the (n+1)-th target being closer to a current location of the vehicle than an end point associated with the n-th target, and
wherein the “n” is a natural number.

13. The apparatus of claim 1, wherein the processor is configured to:
control the speed of the vehicle such that the speed of the vehicle is maintained at the target speed until the vehicle reaches a point at which the at least one target is located relative to the end point; and
control the speed of the vehicle such that the speed of the vehicle reaches a speed different from the target speed after the vehicle has passed the point at which the at least one target is located.

14. The apparatus of claim 1, wherein the parameter comprises a Time-Gap parameter expressed in units of time.

15. A method performed by an apparatus for controlling a vehicle, the method comprising:
determining a risk area among a plurality of risk areas, wherein at least one target is located in the risk area, wherein the plurality of risk areas are generated by dividing a sidewalk into a plurality of areas, and wherein the sidewalk is within a threshold distance from a road on which the vehicle is travelling;
determining a start point of a segment associated with the risk area and determining an end point of the segment associated with the risk area, wherein a target speed is set for the risk area; and
controlling a speed of the vehicle from the start point such that the speed of the vehicle reaches the target speed at the end point.

16. The method of claim 15, wherein the dividing the sidewalk comprises dividing the sidewalk into the plurality of areas based on at least one of:
the speed of the vehicle,
a distance detected by a sensor,
a predetermined longitudinal distance from the vehicle,
a predetermined lateral distance from the vehicle, or
a predetermined parameter corresponding to the speed of the vehicle.

17. The method of claim 15, wherein the determining the start point comprises determining the start point based on at least one of the speed of the vehicle, a longitudinal speed of the at least one target, or a predetermined parameter corresponding to the longitudinal speed of the at least one target.

18. The method of claim 16, wherein the dividing the sidewalk comprises identifying a longitudinal distance of the risk area, wherein the longitudinal distance is a greater of the longitudinal distance from the vehicle and the distance detected by the sensor.

19. The method of claim 15, wherein the dividing the sidewalk comprises dividing at least one risk area of the plurality of risk areas into:
a first risk segment that is within a specific longitudinal distance from the vehicle, and
a second risk segment that is outside the specific longitudinal distance from the vehicle, and
wherein a width of the at least one risk area in the second risk segment becomes narrower as the at least one risk area is farther away from the vehicle.

20. The method of claim 15, wherein the determining the start point comprises:
determining, based on detecting a plurality of targets within the plurality of risk areas, at least one of:
a plurality of target speeds for the plurality of targets, wherein each of the plurality of targets corresponds to a respective one of the plurality of target speeds,
a plurality of start points for the plurality of targets, wherein each of the plurality of targets corresponds to a respective one of the plurality of start points, or
an plurality of end points for the plurality of targets, wherein each of the plurality of targets corresponds to a respective one of the plurality of end points; and
wherein the controlling the speed of the vehicle comprises controlling the speed of the vehicle from a start point among the plurality of start points, and wherein the start point is a point closest to the vehicle.
